(19) United States
(12) Patent Application Publication
(10) Pub. No.: US 2023/0229917 A1
(43) Pub. Date: Jul. 20, 2023

(54) HYBRID MULTIPY-ACCUMULATION OPERATION WITH COMPRESSED WEIGHTS

(71) Applicant: Intel Corporation, Santa Clara, CA (US)

(72) Inventors: Michael Wu, Belmont, CA (US); Arnab Raha, San Jose, CA (US); Deepak Abraham Mathaikutty, Chandler, AZ (US); Nihat Tunali, San Jose, CA (US); Martin Langhammer, Alderbury (GB)

(73) Assignee: Intel Corporation, Santa Clara, CA (US)

(21) Appl. No.: 18/184,101

(22) Filed: Mar. 15, 2023

(51) Int. Cl. G06N 3/08; G06F 7/544

(52) U.S. Cl. CPC G06N 3/08; G06F 7/5443

(57) ABSTRACT

A compute block can perform hybrid multiply-accumulate (MAC) operations. The compute block may include a weight compressing module and a processing element (PE) array. The weight compression module may select a first group of one or more weights and a second group of one or more weights from a weight tensor of a DNN (deep neural network) layer. A weight in the first group is quantized to a power of two value. A weight in the second group is quantized to an integer. The integer and the exponent of the power of two value may be stored in a memory in lieu of the original values of the weights. A PE in the PE array includes a shifter configured to shift an activation of the layer by the exponent of the power of two value and a multiplier configured to multiplying the integer with another activation of the layer.

### TECHNICAL FIELD

This disclosure relates generally to neural networks, and more specifically, hybrid MAC (multiply-accumulate) operations with compressed weights in deep neural networks (DNNs).

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as each inference can require hundreds of millions of MAC operations as well as a large amount of data to read and write. Therefore, techniques to improve efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

Figure (FIG.) 1 illustrates an example DNN, in accordance with various embodiments.

FIG. 2 illustrates an example convolution, in accordance with various embodiments.

FIG. 3 is a block diagram of a DNN accelerator, in accordance with various embodiments.

FIG. 4 is a block diagram of a compute block, in accordance with various embodiments.

FIG. 5 illustrates hybrid compression of a weight operand, in accordance with various embodiments.

FIGS. 6A-6D illustrate different processes of partitioning a weight tensor, in accordance with various embodiments.

FIG. 7 illustrates a hybrid MAC operation, in accordance with various embodiments.

FIG. 8 illustrates a processing element (PE) array, in accordance with various embodiments.

FIG. 9 is a block diagram of a PE capable of hybrid MAC operations, in accordance with various embodiments.

FIG. 10 illustrates an example PE capable of hybrid MAC operations, in accordance with various embodiments.

FIG. 11 illustrates another example PE capable of hybrid MAC operations, in accordance with various embodiments.

FIG. 12 illustrates a configurable PE capable of hybrid MAC operations, in accordance with various embodiments.

FIG. 13 illustrates a PE with a compressor and an adder tree, in accordance with various embodiments.

FIG. 14 is a flowchart showing a method of performing a hybrid MAC operation, in accordance with various embodiments.

FIG. 15 is a block diagram of an example computing device, in accordance with various embodiments.

### DETAILED DESCRIPTION

Overview

The last decade has witnessed a rapid rise in AI (artificial intelligence) based data processing, particularly based on DNNs. DNNs are widely used in the domains of computer vision, speech recognition, image, and video processing mainly due to their ability to achieve beyond human-level accuracy. The significant improvements in DNN model size and accuracy coupled with the rapid increase in computing power of execution platforms have led to the adoption of DNN applications even within resource constrained mobile and edge devices that have limited energy availability.

Deep learning operations in DNNs are becoming increasingly important in both datacenter as well as edge applications. Examples of deep learning operations in DNNs include convolution (e.g., standard convolution, depthwise convolution, pointwise convolution, group convolution, etc.), matrix multiplication (e.g., matrix multiplications in transformer networks, etc.), deconvolution, pooling operations, elementwise operations (e.g., elementwise addition, elementwise multiplication, etc.), linear operations, nonlinear operations, other types of deep learning operations, or some combination thereof. One of the main challenges is the massive increase in computational and memory bandwidth required for these operations. Many deep learning operations, such as many convolution and large matrix multiplications, are performed on large data sets. Also, although accuracies of these operations improve over time, these improvements often result in significant increase in both model parameter sizes and operation counts.

To reduce the computational and memory bandwidth requirement for executing DNNs, some approaches focus on efficient deep learning network architectures. Other approaches attempt to reduce computational cost of convolution and matrix multiplication operations. Those approaches include pruning weights and skipping MAC operations of pruned weights that have values of zero, quantizing weights to values of lower precision and using cheaper multipliers with lower precision, replacing multiplications with shift operations by quantizing weights or activations to power of two to reduce complexity, and so on.

For both pruning based methods and quantization methods, retraining or fine-tuning is usually required to recover performance of the DNN, particularly for low bit-width or very sparse weights. However, the typical retraining/fine-tuning process suffers from impairments. For instance, retraining or fine-tuning usually requires a software infrastructure to enable sparsity. Also, retraining or fine-tuning can be a time-consuming process, particularly for large transformer-based networks. Hyperparameters tuning is often required to obtain satisfactory accuracy and acceptable convergence speed. Moreover, the dataset may not always be available from the customer. Therefore, improved technologies for reducing the computational and memory bandwidth requirement for executing DNNs are needed.

Embodiments of the present disclosure may improve on at least some of the challenges and issues described above by compressing weights in a hybrid manner that can facilitate hybrid MAC operations, which require less computational and memory resources than currently available MAC operations. The hybrid MAC operations can be performed by a combination of multipliers and shifters (e.g., arithmetic shifters).

In various embodiments of the present disclosure, a DNN accelerator may be used to execute layers in a DNN. A DNN layer (e.g., a convolutional layer) may have an input tensor (also referred to as “input feature map (IFM)”) including one or more data points (also referred to as “input elements,” “input activations”, or “activations”), a weight tensor including one or more weights, and an output tensor (also referred to as “output feature map (IFM)”) including one or more data points (also referred to as “output elements,” “output activations”, or “activations”). The output tensor is computed by performing one or more deep learning operations on the input tensor and the weight tensor. A tensor is a data structure having multiple elements across one or more dimensions. Example tensors include a vector, which is a one-dimensional tensor, and a matrix, which is a two-dimensional tensor. There can also be three-dimensional tensors and even higher dimensional tensors.

The DNN accelerator may partition a weight tensor of a DNN layer into subtensors. Each subtensor includes a subset of the weights in the weight tensor. In some embodiments, the weight tensor may be a four-dimensional tensor. For instance, the weight tensor may include filters, each of which is a three-dimensional tensor. The fourth dimension of the weight tensor may be the number of filters in the DNN layer. A weight subtensor may have less dimensions than the weight tensor. In some embodiments, the weight tensor of the DNN layer may be referred to as the whole weight tensor of the DNN layer, and a weight subtensor is referred to as a weight tensor, which is a subset of the whole weight tensor of the DNN layer.

The DNN accelerator may compress a weight subtensor in a hybrid manner. For instance, the DNN accelerator selects a first group of one or more weights and a second group of one or more weights from the weight subtensor. The DNN accelerator may quantize each weight in the first group into an integer and quantize each weight in the second group into a power of two value. For instance, the DNN accelerator may determine an integer or power of two value for a weight based on the original value of the weight, e.g., by minimizing the difference between the original value of the weight and the integer or power of two value. For instance, the difference between the original value of the weight and the integer (or the power of two value) may be smaller than the difference between the original value of the weight and any other integers (or any other power of two values).

The DNN accelerator may select the first group based on a predetermined partition parameter. The partition parameter may indicate a ratio of the number of weight(s) in the first group to the total number of weights in the weights subtensor. After the hybrid compression, the DNN accelerator may store the integers and exponents of the power of two values in lieu of the original values of the weights. Compared with the original values of the weights, the integers and exponents of the power of two values have a smaller storage size as they have less bits. Thus, the hybrid compression can reduce memory storage and bandwidth requirement.

The DNN accelerator includes PEs that can perform hybrid MAC operations with the compressed weights. A MAC operation includes multiplications, each of which is a multiplication of an activation with a weight, and accumulations of products computed from the multiplications. A PE performing a hybrid MAC operation include one or more multipliers, one or more shifters, and one or more accumulators. A multiplier may compute a product of an activation with a weight quantized into an integer by multiplying the activation with the integer. A shifter may compute a product of an activation with a weight quantized into a power of two value by shifting the activation by the exponent of the power of two value. A shifter may be an arithmetic shifter. An accumulator may accumulate outputs of multiple multipliers, outputs of multiple shifters, or outputs of at least one multiplier and at least one shifter. As the DNN accelerator uses the one or more shifters in lieu of multipliers, it requires less area and power for executing the DNN layer.

The shift operations by shifters can be faster than multiplications by multipliers. In some embodiments, the DNN accelerator includes one or more adders (e.g., ripple-carry adders), which are smaller and consume less power, to accumulate outputs of the shifters. Additional reduction in area or power can be achieved by using such adders. Even though these adders may be slower, the performance of the DNN accelerator would not be impaired as the shifters can be faster than the multipliers.

The present disclosure can reduce inference power and memory bandwidth while maintaining good classification accuracy. Different from existing quantization and sparsification techniques that require retraining or fine-tuning, the present disclosure can use static calibration to achieve good classification accuracy. Also, the present disclosure can reduce weight memory bandwidth as the number of bits for weights is reduced and weights can be stored in a compressed format. The replacement of multipliers with arithmetic shifters can reduce power (average power and peak power) and area consumed by the DNN accelerator. Therefore, compared with currently available techniques for executing DNNs, the present disclosure provides a technique that requires less computational and memory resources.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

Example DNN

FIG. 1 illustrates an example DNN 100, in accordance with various embodiments. For purpose of illustration, the DNN 100 in FIG. 1 is a CNN. In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as IFM 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as output feature map (OFM) 160). The OFM 160 is represented by a 5×5 2D matrix. The 5×5 2D matrix includes 5 output elements (also referred to as output points) in each row and 5 output elements in each column. For purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is rectified linear unit (ReLU). ReLU is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 performs a convolution on the OFM 160 with new kernels and generates a new feature map. The new feature map may also be normalized and resized. The new feature map can be kernelled again by a further subsequent convolutional layer 110, and so on.

In some embodiments, a convolutional layer 110 has 4 hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between 2 convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be implemented as convolutional or not. The fully connected layers 130 receive an input operand. The input operand defines the output of the convolutional layers 110 and pooling layers 120 and includes the values of the last feature map generated by the last pooling layer 120 in the sequence. The fully connected layers 130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully connected layers 130 multiply each input element by weight, make the sum, and then apply an activation function (e.g., logistic if N=2, softmax if N>2). This is equivalent to multiplying the input operand by the matrix containing the weights. In an example, the vector includes 3 probabilities: a first probability indicating the object 115 being a tree, a second probability indicating the object 125 being a car, and a third probability indicating the object 135 being a person. In other embodiments where the input image 105 includes different objects or a different number of objects, the individual values can be different.

Example Convolution

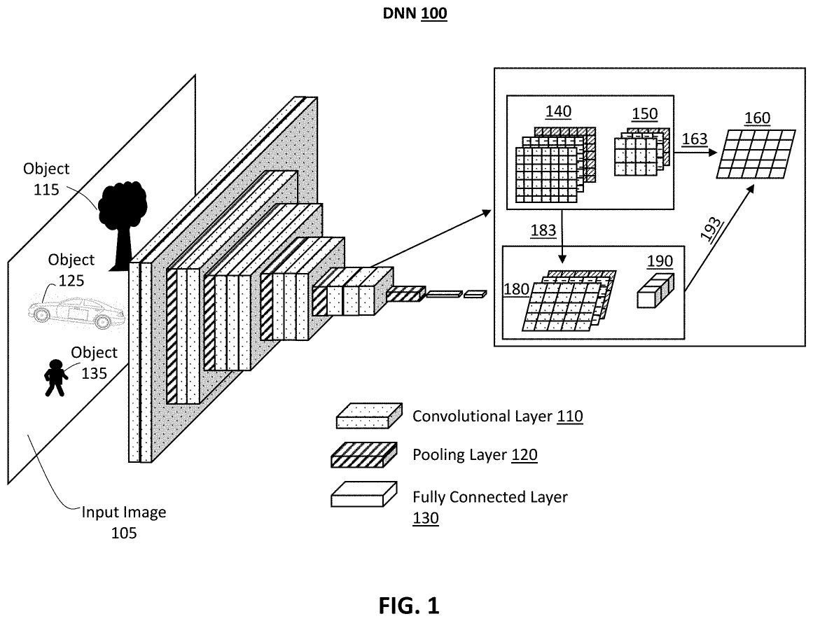

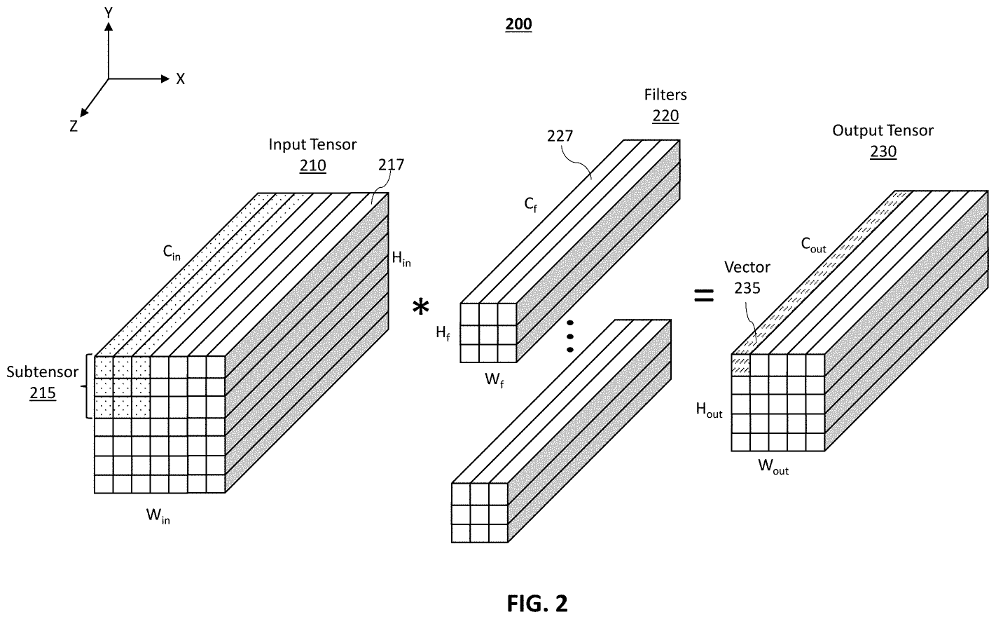

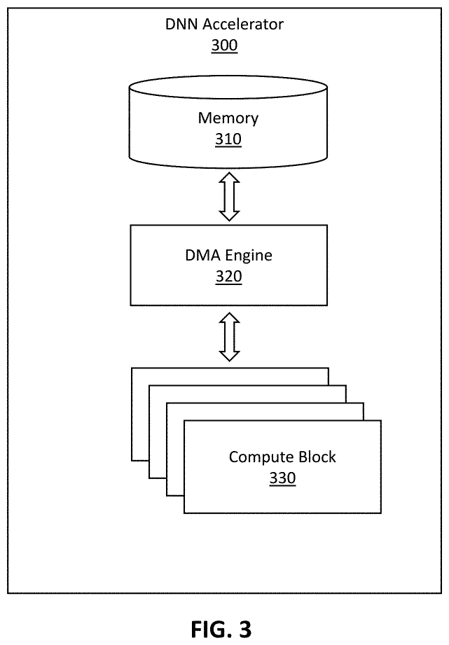

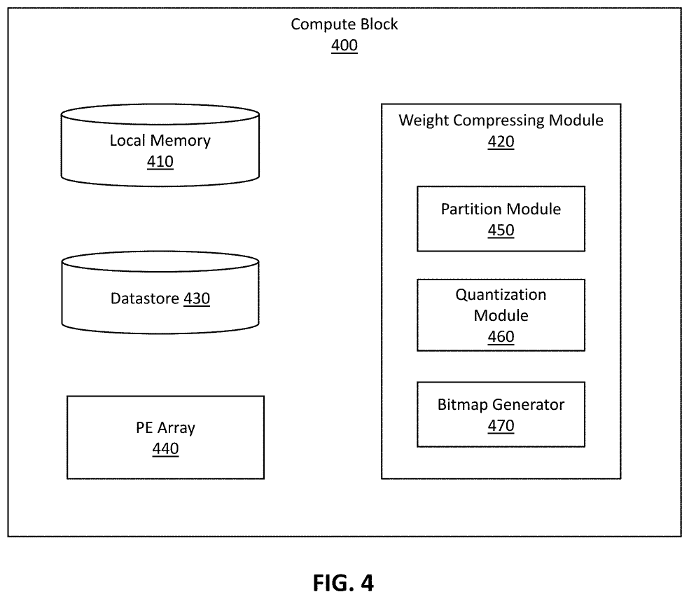

FIG. 2 illustrates an example convolution, in accordance with various embodiments. The convolution may be a convolution in a convolutional layer of a DNN, e.g., a convolutional layer 110 in FIG. 1. The convolution can be executed on an input tensor 210 and filters 220 (individually referred to as “filter 220”). A result of the convolution is an output tensor 230. In some embodiments, the convolution is performed by a DNN accelerator including one or more compute block. An example of the DNN accelerator may be the DNN accelerator 300 in FIG. 3. An example compute block may be the compute block 400 in FIG. 4.

In the embodiments of FIG. 2, the input tensor 210 is a 3D tensor. The input tensor 210 includes activations (also referred to as “input activations,” “elements,” or “input elements”) arranged in a 3D matrix. An activation in the input tensor 210 is a data point in the input tensor 210. The input tensor 210 has a spatial size Hᵢₙ×Wᵢₙ×Cᵢₙ, where Hᵢₙ is the height of the 3D matrix (i.e., the length along the Y axis, which indicates the number of activations in a column in the 2D matrix of each input channel), Wᵢₙ is the width of the 3D matrix (i.e., the length along the X axis, which indicates the number of activations in a row in the 2D matrix of each input channel), and Cᵢₙ is the depth of the 3D matrix (i.e., the length along the Z axis, which indicates the number of input channels). For purpose of simplicity and illustration, the 2D matrix of each input channel has a spatial size of 7×7. In other embodiments, the 2D matrix may have a different spatial size. Cᵢₙ may be an integer that may fall into a range from a small number (e.g., 1, 3, 5, etc.) to a large number (e.g., 100, 500, 1000, or even larger). Each input element in the input tensor 210 may be represented by a (X, Y, Z) coordinate. In other embodiments, the height, width, or depth of the input tensor 210 may be different.

Each filter 220 is a 3D tensor. Each filter includes weights arranged in a 3D matrix. The values of the weights may be determined through training the DNN. A filter 220 has a spatial size H_{f}×W_{f}×C_{f}, where H_{f} is the height of the filter (i.e., the length along the Y axis, which indicates the number of weights in a column in each kernel), W_{f} is the width of the filter (i.e., the length along the X axis, which indicates the number of weights in a row in each kernel), and C_{f} is the depth of the filter (i.e., the length along the Z axis, which indicates the number of channels). In some embodiments, C_{f} equals Cᵢₙ. For purpose of simplicity and illustration, each kernel in FIG. 2 has a spatial size of 3×3. In other embodiments, the height or width of a kernel may be different. The spatial size of the convolutional kernels may be smaller than the spatial size of the 2D matrix of each input channel in the input tensor 210.

The number of filters 220 in the convolution may be equal to Cₒᵤₜ, i.e., the number of output channels that is described below. Cₒᵤₜ may be an integer that may fall into a range from a small number (e.g., 2, 3, 5, etc.) to a large number (e.g., 100, 500, 1000, or even larger). All the filters 220 may constitute a weight tensor of the convolution 200. The weight tensor is a four-dimensional tensor having a spatial size of H_{f}×W_{f}×Cᵢₙ×Cₒᵤₜ. Even though FIG. 2 shows multiple filters 220, the convolution 200 may include a single filter 220 and Cₒᵤₜ=1, in which case the weight tensor of the convolution 200 is a three-dimensional tensor. In some embodiments, H_{f} and W_{f} may equal zero, and the weight tensor of the convolution 200 is a two-dimensional tensor.

An activation or weight may take one or more bytes in a memory. The number of bytes for an activation or weight may depend on the data format. For example, when the activation or weight has an integral format (e.g., INT8), the activation takes one byte. When the activation or weight has a floating-point format (e.g., FP16 or BF16), the activation or weight takes two bytes. Other data formats may be used for activations or weights. Activations or weights may be compressed to save memory and compute resources, such as memory storage, data transfer bandwidth, power consumed for processing activations or weights, and so on.

In some embodiments, weights may be quantized to integers or power of two values. For instance, some weights may be quantized to integers, while the other weights may be quantified to power of two values. The integers or exponents of the power of two values may be stored in lieu of the original values of the weights to save memory storage and data transfer bandwidth. Also, hybrid MAC operations may be performed to compute the output tensor 230. The hybrid MAC operations include multiplications of integers, which are generated by quantizing weights, and activations. Compared with multiplications of floating points, the multiplications of integers can be faster and consume less energy. The hybrid MAC operations also include shift operations or weights that are quantized to power of two values. The shift operations may be performed by shifters that shift the corresponding activations by exponents of the power of two values. The shifters may be faster or consume less energy compared with multipliers. More details regarding quantizing weights are described below in conjunction with FIGS. 4-6. More details regarding hybrid MAC operations are described below in conjunction with FIGS. 4, 7, and 10-13.

In the convolution, each filter 220 slides across the input tensor 210 and generates a 2D matrix for an output channel in the output tensor 230. In the embodiments of FIG. 2, the 2D matrix has a spatial size of 5×5. The output tensor 230 includes activations (also referred to as “output activations,” “elements,” or “output element”) arranged in a 3D matrix. An activation in the output tensor 230 is a data point in the output tensor 230. The output tensor 230 has a spatial size Hₒᵤₜ×Wₒᵤₜ×Cₒᵤₜ, where Hₒᵤₜ is the height of the 3D matrix (i.e., the length along the Y axis, which indicates the number of output activations in a column in the 2D matrix of each output channel), Wₒᵤₜ is the width of the 3D matrix (i.e., the length along the X axis, which indicates the number of output activations in a row in the 2D matrix of each output channel), and Cₒᵤₜ is the depth of the 3D matrix (i.e., the length along the Z axis, which indicates the number of output channels). Hₒᵤₜ and Wₒᵤₜ may be dependent on Hᵢₙ, Wᵢₙ, H_{f}, and W_{f}. Cₒᵤₜ may equal the number of filters 220 in the convolution. Hₒᵤₜ and Wₒᵤₜ may depend on the heights and weights of the input tensor 210 and each filter 220.

As a part of the convolution, MAC operations can be performed on a 3×3×Cᵢₙ subtensor 215 (which is highlighted with dot patterns in FIG. 2) in the input tensor 210 and each filter 220. The result of the MAC operations on the subtensor 215 and one filter 220 is an output activation. In some embodiments (e.g., embodiments where the convolution is an integral convolution), an output activation may include 8 bits, e.g., one byte. In other embodiments (e.g., embodiments where the convolution is a floating-point convolution), an output activation may include more than one byte. For instance, an output element may include two bytes.

After the MAC operations on the subtensor 215 and all the filters 220 are finished, a vector 235 is produced. The vector 235 is highlighted with slashes in FIG. 2. The vector 235 includes a sequence of output activations, which are arranged along the Z axis. The output activations in the vector 235 have the same (x, y) coordinate, but the output activations correspond to different output channels and have different Z coordinates. The dimension of the vector 235 along the Z axis may equal the total number of output channels in the output tensor 230.

After the vector 235 is produced, further MAC operations are performed to produce additional vectors till the output tensor 230 is produced. For instance, a filter 220 may move over the input tensor 210 along the X axis or the Y axis, and MAC operations can be performed on the filter 220 and another subtensor in the input tensor 210 (the subtensor has the same size as the filter 220). The amount of movement of a filter 220 over the input tensor 210 during different compute rounds of the convolution is referred to as the stride size of the convolution. The stride size may be 1 (i.e., the amount of movement of the filter 220 is one activation), 2 (i.e., the amount of movement of the filter 220 is two activations), and so on. The height and width of the output tensor 230 may be determined based on the stride size.

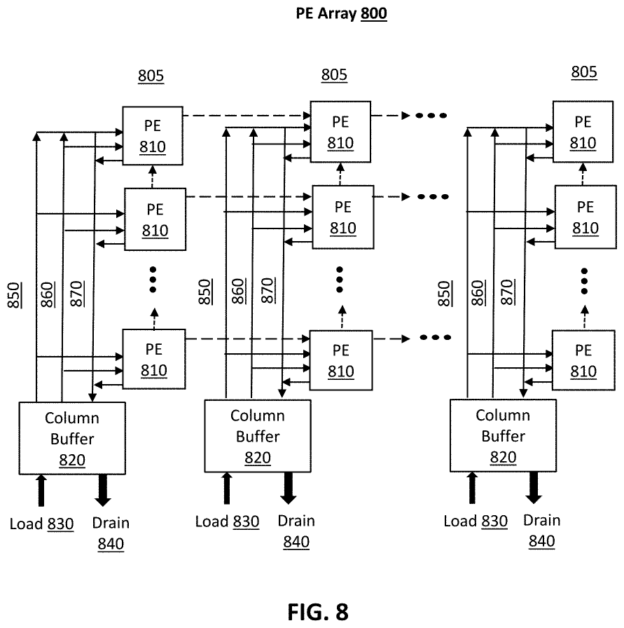

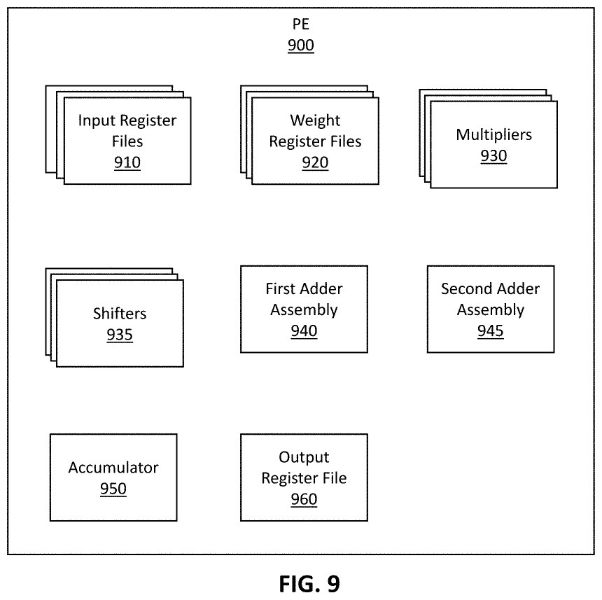

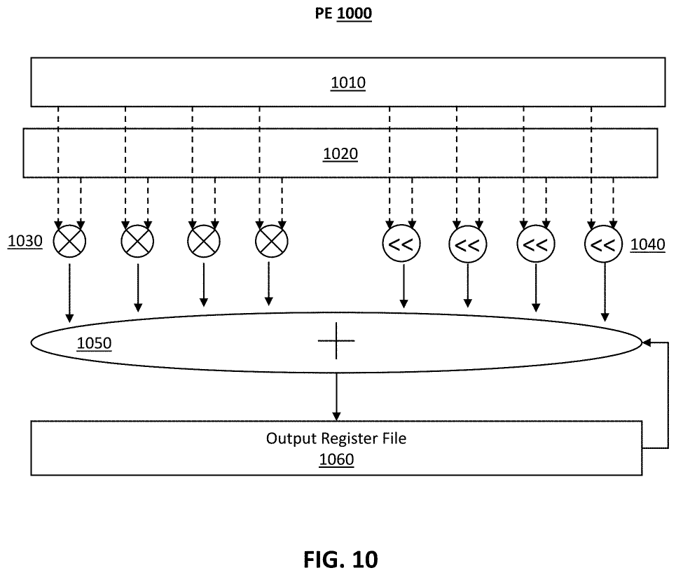

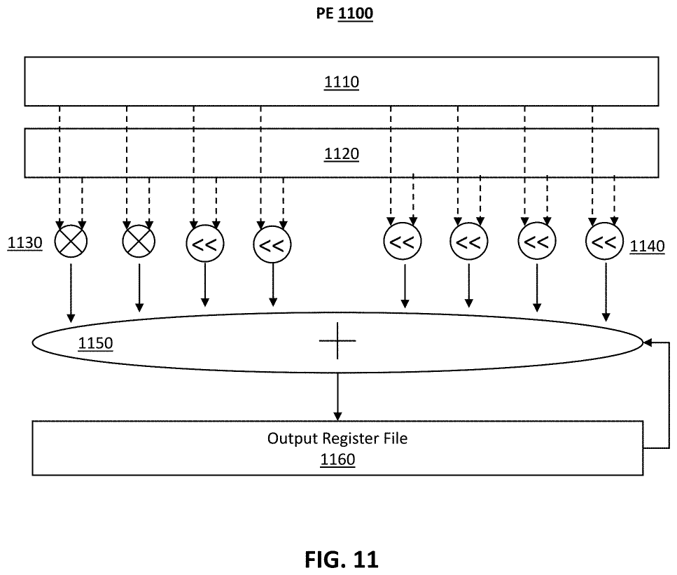

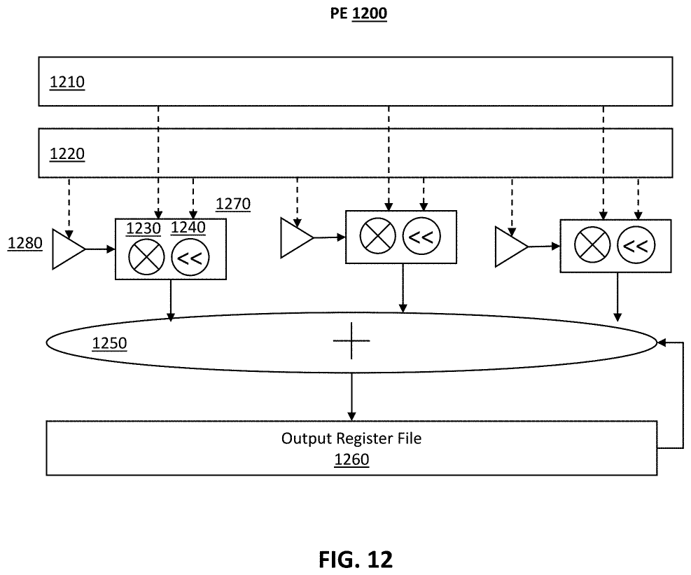

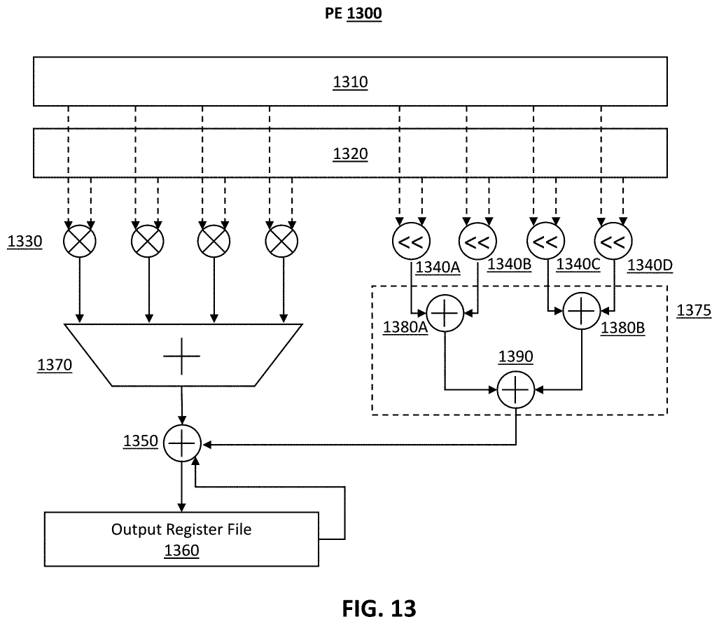

In some embodiments, the MAC operations on a 3×3×Cᵢₙ subtensor (e.g., the subtensor 215) and a filter 220 may be performed by a plurality of PEs, such as the PEs 810 in FIG. 8, the PE 900 in FIG. 9, the PE 1000 in FIG. 10, the PE 1100 in FIG. 11, the PE 1200 in FIG. 12, or the PE 1300 in FIG. 13. One or more PEs may receive an input operand (e.g., an input operand 217 shown in FIG. 2) and a weight operand (e.g., the weight operand 227 shown in FIG. 2). The input operand 217 includes a sequence of activations having the same (X, Y) coordinate but different Z coordinates. The weight operand 227 includes a sequence of weights having the same (X, Y) coordinate but different Z coordinates. The length of the input operand 217 is the same as the length of the weight operand 227. Activations in the input operand 217 and weights in the weight operand 227 may be sequentially fed into a PE. The PE may receive a pair of an activation and a weight at a time and multiple the activation and the weight. The position of the activation in the input operand 217 may match the position of the weight in the weight operand 227.

Example DNN Accelerator

FIG. 3 is a block diagram of a DNN accelerator 300, in accordance with various embodiments. The DNN accelerator 300 can run DNNs, e.g., the DNN 100 in FIG. 1. The DNN accelerator 300 includes a memory 310, a DMA (direct memory access) engine 320, and compute blocks 330. In other embodiments, alternative configurations, different or additional components may be included in the DNN accelerator 300. For example, the DNN accelerator 300 may include more than one memory 310 or more than one DMA engine 320. As another example, the DNN accelerator 300 may include a single compute block 330. Further, functionality attributed to a component of the DNN accelerator 300 may be accomplished by a different component included in the DNN accelerator 300 or by a different system.

The memory 310 stores data to be used by the compute blocks 330 to perform deep learning operations in DNN models. Example deep learning operations include convolutions (also referred to as “convolutional operations”), matrix multiplication (e.g., matrix multiplications in transformer networks, etc.), pooling operations, elementwise operations, other types of deep learning operations, or some combination thereof. The memory 310 may be a main memory of the DNN accelerator 300. In some embodiments, the memory 310 includes one or more DRAMs (dynamic random-access memory). For instance, the memory 310 may store the input tensor, convolutional kernels, or output tensor of a convolution in a convolutional layer of a DNN, e.g., the convolutional layer 30. The output tensor can be transmitted from a local memory of a compute block 330 to the memory 310 through the DMA engine 320.

The DMA engine 320 facilitates data transfer between the memory 310 and local memories of the compute blocks 330. For example, the DMA engine 320 can read data from the memory 310 and write data into a local memory of a compute block 330. As another example, the DMA engine 320 can read data from a local memory of a compute block 330 and write data into the memory 310. The DMA engine 320 provides a DMA feature that allows the compute block 330 to initiate data transfer between the memory 310 and the local memories of the compute blocks 330 and to perform other operations while the data transfer is in being conducted. In some embodiments, the DMA engine 320 may read tensors from the memory 310, modify the tensors in a way that is optimized for the compute block 330 before it writes the tensors into the local memories of the compute blocks 330.

The compute blocks 330 perform computations to execute deep learning operations. A compute block 330 may run one or more deep learning operations in a DNN layer, or a portion of the deep learning operations in the DNN layer. A compute block 330 may perform convolutions, such as standard convolution (e.g., the standard convolution 163 in FIG. 1), depthwise convolution (e.g., the depthwise convolution 183 in FIG. 1), pointwise convolution (e.g., the pointwise convolution 193 in FIG. 1), and so on. In some embodiments, the compute block 330 receive an input tensor and one or more convolutional kernels and performs a convolution with the input tensor and convolutional kernels. The result of the convolution may be an output tensor, which can be further computed, e.g., by the compute block 330 or another compute block.

A compute block 330 may facilitate hybrid MAC operations. A hybrid MAC operation includes one or more multiplications and one or more shift operations. The compute block 330 may compress weights of a DNN layer in a hybrid manner. For instance, some weights may be compressed into integers while other weights may be compressed into power of two values. In the hybrid MAC operation, the integers may be processed by multipliers, while exponents of the power of two values may be processed by shifters.

The compute block 330 may also perform other types of deep learning operations, such as matrix multiplication (e.g., matrix multiplications in transformer networks, etc.), pooling operations, elementwise operations, deconvolution, linear operations, nonlinear operations, and so on. A compute block 330 may execute one or more DNN layers. In some embodiments, a DNN layer may be executed by multiple compute blocks 330 in parallel. For instance, multiple compute blocks 330 may each perform a portion of a workload for a convolution. Data may be shared between the compute blocks 330. Certain aspects of the compute block are described below in conjunction with FIG. 4.

FIG. 4 is a block diagram of a compute block 400, in accordance with various embodiments. The compute block 400 may execute deep learning operations in a DNN during the training, inference, or both stages of the DNN. The compute block 400 may be an embodiment of the compute block 330 in FIG. 3. As shown in FIG. 4, the compute block 400 includes a local memory 410, a weight compressing module 420, a datastore 430, and a PE array 440. In other embodiments, alternative configurations, different or additional components may be included in the compute block 400. For instance, the compute block 400 may include more than one local memory 410, weight compressing module 420, datastore 430, or PE array 440. Further, functionality attributed to a component of the compute block 400 may be accomplished by a different component included in the compute block 400, another component of the DNN accelerator 300, or by a different system.

The local memory 410 is local to the compute block 400. In the embodiments of FIG. 3, the local memory 410 is inside the compute block 400. In other embodiments, the local memory 410 may be outside the compute block 400. The local memory 410 and the compute block 400 can be implemented on the same chip. In some embodiments, the local memory 410 includes one or more SRAMs (static random-access memories). The local memory 410 may be byte-addressable, and each memory address identifies a single byte (eight bits) of storage. In some embodiments, the local memory 410 may include banks, each bank may have a capacity of a fixed number of bytes, such as 22, 64, and so on.

The local memory 410 may store input data (e.g., input tensors, filters, etc.) and output data (e.g., output tensors, etc.) of deep learning operations run by the compute block 400. A tensor may include elements arranged in a vector, a 2D matrix, a 3D matrix, or a 4D matrix. Data stored in the local memory 410 may be in compressed format. For instance, for a tensor including one or more nonzero-valued elements and one or more zero-valued elements, the local memory 410 may store the one or more nonzero-valued elements and not store the one or more zero-valued elements.

The local memory 410 may store weights in a hybrid compressed format. For instance, the local memory 410 may store integers and power of two values that are generated by quantizing weights in a weight tensor. The local memory 410 may also store other data associated with deep learning operations run by the compute block 400, such as compression bitmaps to be used for hybrid MAC operations. A compression bitmap may include a plurality of bits, each of which may correspond to a weight in a weight tensor and indicate whether the weight was quantized into an integer or a power of two value.

The weight compressing module 420 compresses weight tensors in a hybrid manner. For instance, the weight compressing module 420 compresses some weights in a weight tensor by quantizing the weights into integers while compresses other weights in the weight tensor by quantizing these weights into power of two values. The weight compressing module 420 may also generate a compression bitmap that indicates which weights are quantized into integers and which weights are quantized into power of two values.

As shown in FIG. 4, the weight compressing module 420 includes a partition module 450, a quantization module 460, and a bitmap generator 470. In other embodiments, alternative configurations, different or additional components may be included in the weight compressing module 420. For instance, the weight compressing module 420 may include more than one partition module 450, quantization module 460, or bitmap generator 470. Further, functionality attributed to a component of the weight compressing module 420 may be accomplished by a different component included in the weight compressing module 420, another component of the compute block 400, another component of the DNN accelerator 300, or by a different system.

The partition module 450 partitions a weight tensor of a DNN layer into subtensors. In some embodiments, the weight tensor may be a four-dimensional tensor. For instance, the weight tensor may include filters, each of which is a three-dimensional tensor having a spatial size of H_{f}×W_{f}×Cᵢₙ where H_{f} is the height, W_{f} is the width, and Cᵢₙ is the depth that is equal to the number of input channels in the IFM of the DNN layer. The number of filters in the weight tensor may equal Cₒᵤₜ, i.e., the number of output channels in the output feature map of the DNN layer.

In some embodiments, the partition module 450 partitions a weight tensor into a plurality of weight subtensors, each of which may have a spatial size of 1×1×Cᵢₙ×Cₒᵤₜ. A weight subtensor is a two-dimensional tensor having a width of Cᵢₙ and a height of Cₒᵤₜ. The number of weights in a row of the weight subtensor is Cᵢₙ, and the number of weights in a column of the weight subtensor is Cₒᵤₜ. In other embodiments, the weight tensor may be partitioned into subtensors having different spatial sizes or different dimensions.

The partition module 450 may further partition a weight subtensor into a first group and a second group, each of which includes one or more weights in the weight tensors. Each respective weight in the first group may be quantized into an integer, each respective weight in the second group may be quantized into a power of two value. The integer may be in a range from a small number (e.g., 0, 1, 2, 3, etc.) to a large number (e.g., 100, 500, 1000, etc.). The power of two value may be denoted as 2^{e}, where e is the exponent of the power of two value and may be in a range from a small number to a large number. In some embodiments, a weight in the weight subtensor is either in the first group or in the second group, instead of being included in both groups. In some embodiments, the partition module 450 may partition the weight subtensor based on a predetermined partition parameter. The partition parameter may indicate a ratio of the number of weight(s) in the first group to the total number of weight(s) in the weight subtensor. In some embodiments, the partition parameter may be a percentage. In embodiments where the partition parameter is denoted asp and the total number of weights in the weight subtensor is denoted as N, the partition module 450 may select p×N weights as the first group and select (1−p)×N weights as the second group.

In some embodiments, the partition module 450 may use the same partition parameter for partitioning multiple weight subtensors. In other embodiments, the partition module 450 may use different partition parameters for different weight subtensors. For example, the partition module 450 may partition a weight subtensor into a first group including half of the weight and a second group including the other half of the weights, versus partition another weight subtensor into a first group including a quarter of the weight and a second group including the other three quarters of the weights.

In some embodiments, the weight subtensor may be a two-dimensional tensor having weights arranged in rows and columns. In embodiments where the weight subtensor has a height of H and a width of W, N may equal H×W. The partition module 450 may partition the columns in the weight subtensor separately. For instance, for each respective column, the partition module 450 may select one or more weights to be included in the first group or one or more other weights to be included in the second group. In some embodiments, the partition module 450 partitions a column by minimizing a Euclidean norm (i.e., L² norm), which may be denoted as:

L²=\sqrt{Σ₁ⁿ(wᵢ−wᵢ′)²}

where i is the index of a weight in the column, n is the total number of weights in the column, wᵢ is the original value of the weight (i.e., the value of the weight before the hybrid compression), and wᵢ′ is the integer or the power of two value computed by quantizing the weight (i.e., the value of the weight after the hybrid compression).

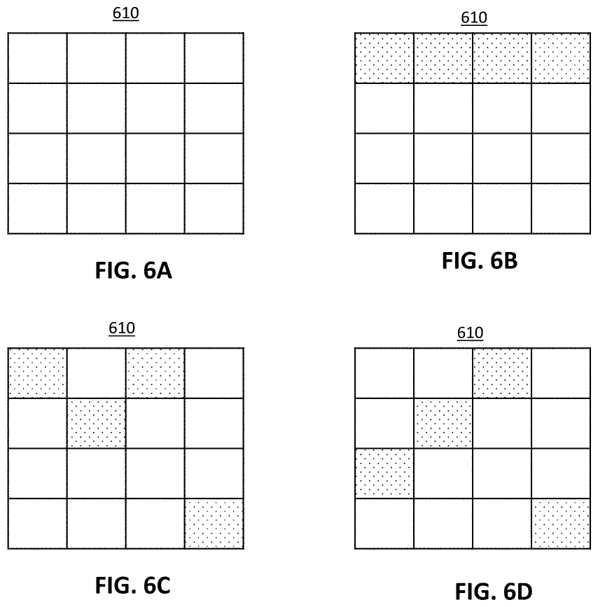

In some embodiments, the partition module 450 may select the same number of weight(s) from each respective row of the weight subtensor as weight(s) in the first group, e.g., for the purpose of balancing computation workloads between compute pipelines. In an example, the weight subtensor may include a number W rows, and the partition module 450 may select a number P weights as the first group by selecting a number P/W weight(s) from every row in the weight subtensor. More details regarding partitioning weight subtensors are described below in conjunction with FIGS. 6A-6D.

The quantization module 460 quantizes each weight in the first group into an integer and quantize each weight in the second group into a power of two value. In some embodiments, for a weight in the first group, the quantization module 460 may determine an integer for the weight based on the original value of the weight, e.g., by minimizing the difference between the original value of the weight and the integer. For instance, the difference between the original value of the weight and the integer (or the power of two value) may be smaller than the difference between the original value of the weight and any other integers. The integer may have the same sign (positive or negative) as the original value of the weight. For a weight in the second group, the quantization module 460 may determine a power of two value for the weight based on the original value of the weight, e.g., by minimizing the difference between the original value of the weight and the power of two value. For instance, the difference between the original value of the weight and the power of two value may be smaller than the difference between the original value of the weight and any other power of two values. The power of two value may have the same sign (positive or negative) as the original value of the weight.

The integers and exponents of the power of two values may be stored in the local memory 410 or the datastore 430. In some embodiments, the quantization module 460 may receive the original values of the weights from the local memory 410 or the memory 310. The quantization module 460 may store the integers and exponents of the power of two values, which are generated by quantizing the original values of the weights, in the local memory 410 or the datastore 430. Compared with the original values of the weights, the integers and exponents of the power of two values have a smaller storage size as they have less bits. Thus, the hybrid compression can reduce memory storage and bandwidth requirement.

The bitmap generator 470 generates compression bitmaps for weight subtensor compressed by the weight compressing module 420. In some embodiments, the bitmap generator 470 generates a compression bitmap for a weight subtensor. The compression bitmap includes a plurality of bits, each of which corresponds to a respective weight in the subtensor. A bit indicates whether the corresponding weight is in the first group or in the second group, i.e., whether the corresponding weight is quantized into an integer or a power of two value. In an example, a zero-valued bit indicates that the corresponding weight is quantized into a power of two value, versus a one-valued bit indicates the corresponding weight is quantized into an integer. The bits in the compression bitmap may be arranged in a sequence. The position of a bit in the compression bitmap may match the position of the corresponding weight in the weight subtensor.

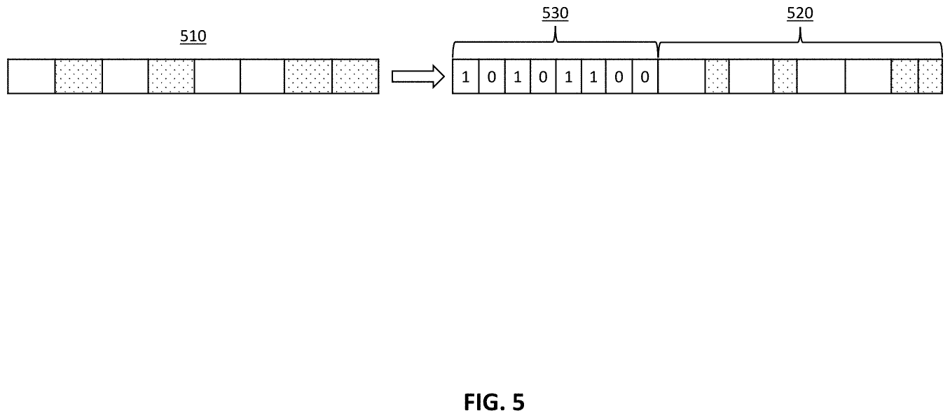

Compression bitmaps generated by the bitmap generator 470 may be stored in the local memory 410 or datastore 430. In some embodiments, a weight subtensor and its compression bitmap may be stored as a single data packet. For instance, the compression bitmap may be a header of the data packet. Despite the addition of the bits in the compression bitmaps, the total storage size can still be smaller than the storage size of the weight subtensor before the hybrid compression. Thus, memory space and bandwidth can still be saved. More details regarding compression bitmap are described below in conjunction with FIG. 5.

The datastore 430 stores data to be used by the PE array 440 for executing deep learning operations. The datastore 430 may function as one or more buffers between the local memory 410 and the PE array 440. Data in the datastore 430 may be loaded from the local memory 410 and can be transmitted to the PE array 440 for computations. In some embodiments, the datastore 430 includes one or more databanks. A databank may include a sequence of storage units. A storage unit may store a portion of the data in the databank. In some embodiments, the storage units may have a fixed storage size, e.g., 32, 64, 126 bytes. The number of storage units in the datastore 430 may be 8, 16, 32, 64, and so on.

A storage unit may be a buffer for a PE at a time. Data in a storage unit may be fed into one or more PEs for a computation cycle of the PEs. For different computation cycles, the storage unit may be the buffer of different PEs. Data in a storage unit may be fed to the PE array 440 through a MAC lane. A MAC lane is a path for loading data into the PE array 440 or a portion of the PE array 440, such as a PE column in the PE array 440. A MAC lane may be also referred to as a data transmission lane or data load lane. The PE array 440 (or a PE column) may have multiple MAC lanes. The loading bandwidth of the PE array 440 (or a PE column) is an aggregation of the loading bandwidths of all the MAC lanes associated with the PE array 440 (or the PE column). In an example where the PE array 440 (or a PE column in the PE array 440) has four MAC lanes and each MAC lane may have a bandwidth of 16 bytes, the four MAC lanes can have a total loading bandwidth of 64 bytes. With N MAC lanes (where N is an integer), data may be fed into N PEs simultaneously. In some embodiments (e.g., embodiments where every PE column has a separate MAC lane), the data in a storage unit may be broadcasted to multiple PE columns through the MAC lanes of these PE columns. In an embodiment where every PE column has more than one separate MAC lane, data in more than one storage unit can be broadcasted to multiple PE columns. In an example where each PE column has four MAC lanes, data in four storage units can be broadcasted to multiple PE columns.

In some embodiments, the datastore 430 may store at least a portion of an input tensor (e.g., the input tensor 210), at least a portion of a weight tensor (e.g., the weight tensor including the filters 220), at least a portion of an output tensor (e.g., the output tensor 230), or some combination thereof. A storage unit may store at least a portion of an operand (e.g., an input operand or a weight operand). An operand may be a subtensor (e.g., a vector, two-dimensional matrix, or three-dimensional matrix) of an input tensor or weight tensor. The storage unit may also store compression bitmaps of weight subtensors. In some embodiments (e.g., embodiments where the local memory 410 stores input data in compressed format), the input data in the datastore 430 is in compressed format. For example, the datastore 430 stores nonzero-valued activations or weights, but zero-valued activations or weights are not stored in the datastore 430. As another example, for a weight tensor or subtensor, the datastore 430 stores integers and exponents of power of two values that are generated by quantizing the weights in the weight tensor or subtensor.

The PE array 440 performs MAC operations (including hybrid MAC operations) in convolutions. The PE array 440 may perform other deep learning operations. The PE array 440 may include PEs arranged in columns, or columns and rows. Each PE can perform MAC operations. In some embodiments, a PE includes one or more multipliers for performing multiplications. An PE may also include one or more adders for performing accumulations. A column of PEs is referred to as a PE column. A PE column may be associated with one or more MAC lanes. A MAC lane is a path for loading data into a PE column. A MAC lane may be also referred to as a data transmission lane or data load lane. A PE column may have multiple MAC lanes. The loading bandwidth of the PE column is an aggregation of the loading bandwidths of all the MAC lanes associated with the PE column. With a certain number of MAC lanes, data can be fed into the same number of independent PEs simultaneously. In some embodiments where a PE column has four MAC lanes for feeding activations or weights into the PE column and each MAC lane may have a bandwidth of 16 bytes, the four MAC lanes can have a total loading bandwidth of 64 bytes.

In some embodiments, the PE array 440 may be capable of standard convolution, depthwise convolution, pointwise convolution, other types of convolutions, or some combination thereof. In a depthwise convolution, a PE may perform an MAC operation that include a sequence of multiplications for an input operand (e.g., the input operand 217) and a weight operand (e.g., the weight operand 227). Each multiplication in the sequence is a multiplication of a different activation in the input operand with a different weight in the weight operand. The activation and weight in the same cycle may correspond to the same channel. The sequence of multiplication produces a product operand that includes a sequence of products. The MAC operation may also include accumulations in which multiple product operands are accumulated to produce an output operand of the PE. The PE array 440 may output multiple output operands at a time, each of which is generated by a different PE. In a standard convolution, MAC operations may include accumulations across the channels. For instance, as opposed to generating an output operand, a PE may accumulate products across different channels to generate a single output point.

In some embodiments, a PE may perform multiple rounds of MAC operations for a convolution. Data (activations, weights, or both) may be reused within a single round, e.g., across different multipliers in the PE, or reused across different rounds of MAC operations. More details regarding PE array are described below in conjunction with FIGS. 5 and 6.

In some embodiments (e.g., embodiments where the compute block 400 executes a convolutional layer), a computation in a PE may be a MAC operation on an input operand and a weight operand. The input operand may be a portion of the input tensor of the convolution. The input operand includes a sequence of input elements, aka activations. The activations may be from different input channels. For instance, each activation is from a different input channel from all the other activations in the input operand. The weight operand may be a portion of a kernel of the convolution. The weight operand includes a sequence of weights. The values of the weights are determined through training the DNN. The weights in the weight operand may be from different input channels. For instance, each weight is from a different input channel from all the other weights in the weight operand. The PE may perform a multiplication on each activation-weight pair by multiplying an activation with a corresponding weight. The position of the activation in the input operand may match (e.g., be the same as) the position of the corresponding weight in the weight operand. The PE may also accumulate products of the activation-weight pairs to compute a partial sum of the MAC operation.

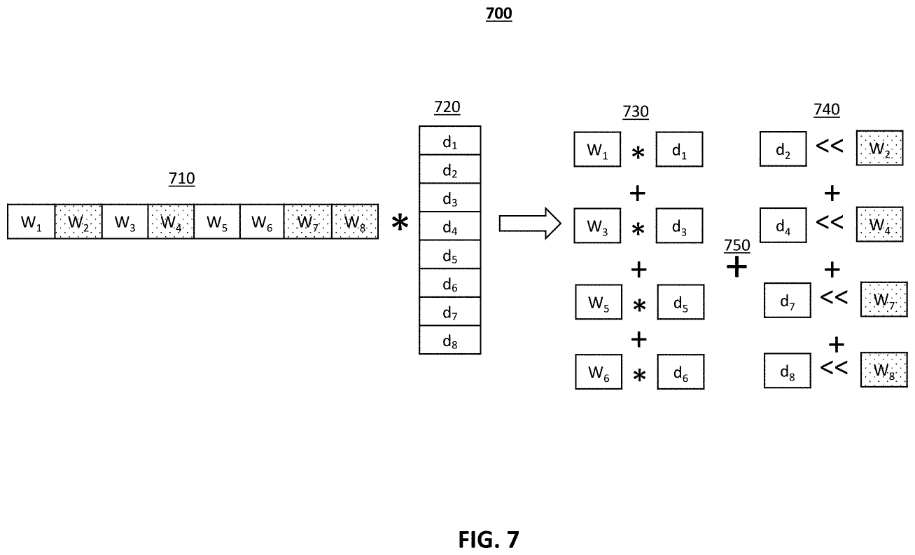

In some embodiments, a PE may perform a hybrid MAC operation with weights that have been compressed in a hybrid manner. The PE may include one or more multipliers, one or more shifters, and one or more accumulators. The weights may be distributed to the one or more multipliers and the one or more shifters based on a compression bitmap associated with the weights. For instance, a weight, which corresponds to a bit in the compressing bitmap that indicates that the weight was quantized to an integer, is transmitted to a multiplier. The multiplier can multiply the weight with the corresponding activation. A weight, which corresponds to a bit in the compressing bitmap that indicates that the weight was quantized to a power of two value, is transmitted to a shifter. The shifter can shift the bits the corresponding activation (e.g., shift left) by the exponent of the power of two value. The one or more accumulators can sum the outputs of the one or more multipliers and the one or more shifters and generate a partial sum of the hybrid MAC operation. More details regarding hybrid MAC operation are described below in conjunction with FIGS. 7 and 10-13. More details regarding PE are described below in conjunction with FIGS. 8 and 9.

Example Hybrid Compression

FIG. 5 illustrates hybrid compression of a weight operand 510, in accordance with various embodiments. The hybrid compression may be performed by the weight compressing module 420 in FIG. 4. The weight operand 510 includes eight weights, each of which is represented by a box in FIG. 5. The weight operand 510 may be a subtensor of a weight tensor of a DNN layer. For the purpose of illustration, the weight operand 510 is a vector. In other embodiments, the weight operand 510 may be a two-dimensional or three-dimensional tensor. Also, the weight operand 510 may include a different number of weights.

Four weights in the weight operand 510, represented by shaded boxes, are selected for being quantized into power of two values. The other four weights, represented by white boxes, are selected for being quantized into integers. After the hybrid compression, a compressed weight operand 520 is generated. The compressed weight operand 520 includes the same number of elements as the weight operand 510. A weight selected for being quantized into an integer has an integral value in the compressed weight operand 520. For instance, the integral value may be the original value of the weight in embodiments where the original value is an integer, while in embodiments where the original value is not an integer (e.g., is a floating-point value), the integral value is different the original value and may have less bits than the original value. For a weight selected for being quantized into a power of two value, the compressed weight operand 520 has the exponent of the power of two value, which has less bits than the original value of the bit. The compressed weight operand 520 has less bits than the weight operand 510 and therefore requires less memory storage space and bandwidth.

The compressed weight operand 520 is associated with a compression bitmap 530, which includes eight bits. Each respective one of the eight bits corresponds to a weight in the weight operand 510 and indicates whether the weight was quantized into an integer or power of two value. In the embodiments of FIG. 5, a bit of 1 indicates that the weight was quantized into an integer, versus of bit of 0 indicates that the weight was quantized into a power of two value. The compression bitmap 530 may be stored in a memory (e.g., the local memory 410 or the datastore 430) as a header of the compressed weight operand 520. Even though that adds extra eight bits into the data, the total number of bits in the compression bitmap 530 plus the compressed weight operand 520 is still less than the number of bits in the weight operand 510.

Example Weight Tensor Partition

FIGS. 6A-6D illustrate different processes of partitioning a weight tensor 610, in accordance with various embodiments. The partitioning of the weight tensor 610 may be performed by the partition module 450 in FIG. 4. FIG. 6A shows a weight tensor 610 having a spatial size of 4×4, i.e., the weight tensor 610 is a two-dimensional tensor including 16 weights arranged in four columns and four rows. Each weight in the weight tensor 610 is represented by a box in FIGS. 6A-6D. The weight tensor 610 may be a subtensor of a whole weight tensor of a DNN layer. In other embodiments, the weight tensor 610 may be a vector or a three-dimensional tensor. Also, the weight tensor 610 may include a different number of weights.

In the embodiments of FIGS. 6B-6D, the weight tensor 610 is partitioned based on a partition parameter equal to 0.25, meaning the weight tensor 610 is partitioned into a first group including a quarter of the 16 weights (i.e., four weights) and a second group including three quarters of the 16 weights (i.e., 12 weights). In FIG. 6B, the four weights in the first row are selected as the first group. The four weights may be selected by partitioning the four columns separately. In FIG. 6C, two weights in the first row, a weight in the second row, and a weight in the fourth row are selected as the first group. The four weights may be selected by partitioning the four columns separately, e.g., by minimizing a norm in distances between the weights before and after the hybrid compression.

In FIG. 6C, the four weights in the first group come from all the four rows, and a single weight is selected in each respective row. In some embodiments, the partitioning in FIG. 6C may be performed after the partitioning in FIG. 6B for the purpose of balancing workload of compute pipelines. The partitioning in FIG. 6B may result in unbalanced pipelines as the rows in the weight tensor 610 do not have the same number of power of two values, while the partitioning in FIG. 6C can achieve balanced pipelines since the number of power of two values are the same for all the four rows.

Example Hybrid MAC Operation

FIG. 7 illustrates a hybrid MAC operation 700, in accordance with various embodiments. The hybrid MAC operation 700 may be performed by a PE, e.g., a PE in the PE array 440 in FIG. 4. The hybrid MAC operation 700 has two inputs: a weight operand 710 and an input operand 720. The weight operand 710 includes eight weights, each of which is represented by a box in FIG. 7. The weight operand 710 may be a subtensor of a weight tensor of a DNN layer. For the purpose of illustration, the weight operand 710 is a vector. In other embodiments, the weight operand 710 may be a two-dimensional or three-dimensional tensor. Also, the weight operand 710 may include a different number of weights. The input operand 720 includes eight activations, each respective activation corresponds to a different weight in the weight operand 710. For instance, the activation d₁ corresponds to the weight w₁, the activation d₂ corresponds to the weight w₂, the activation d₃ corresponds to the weight w₃, and so on.

In a conventional MAC operation, a multiplication may be performed on each activation-weight pair, and the products of the multiplication may be accumulated to generate a partial sum. In the hybrid MAC operation 700, shift operations are also performed. A subset of the weight operand 710 (i.e., w₂, w₄, w₇, and w₈ represented by shaded boxes in FIG. 7) is quantized into power of two values. The other weights (i.e., w₁, w₃, w₅, and w₆) are quantized into integers.

The four integers are multiplied, respectively, with the corresponding activations (i.e., d₁, d₃, d₅, and d₆) in four multiplications 730 (individually referred to as “multiplication 730”) by four multipliers. A multiplier may be an integer multiplier. The other four activations (i.e., d₂, d₄, d₇, and d₈) are shifted, respectively, by the exponents of the four power of two values in four shift operations 740 (individually referred to as “shift operation 740”) by four shifters. The outputs of the multiplications 730 and the output of the shift operations 740 are summed in an accumulation 750 to generate a partial sum of the hybrid MAC operation.

Example PE Array

FIG. 8 illustrates a PE array 800, in accordance with various embodiments. The PE array 800 may be an embodiment of the PE array 440 in FIG. 4. The PE array 800 includes a plurality of PEs 810 (individually referred to as “PE 810”). The PEs 810 perform MAC operations. The PEs 810 may also be referred to as neurons in the DNN. Each PE 810 has two input signals 850 and 860 and an output signal 870. The input signal 850 is at least a portion of an IFM to the layer. The input signal 860 is at least a portion of a filter of the layer. In some embodiments, the input signal 850 of a PE 810 includes one or more input operands, and the input signal 860 includes one or more weight operand.

Each PE 810 performs an MAC operation on the input signals 850 and 860 and outputs the output signal 870, which is a result of the MAC operation. Some or all of the input signals 850 and 860 and the output signal 870 may be in an integer format, such as INT8, or floating-point format, such as FP16 or BF16. For purpose of simplicity and illustration, the input signals and output signal of all the PEs 810 have the same reference numbers, but the PEs 810 may receive different input signals and output different output signals from each other. Also, a PE 810 may be different from another PE 810, e.g., including more, fewer, or different components.

As shown in FIG. 8, the PEs 810 are connected to each other, as indicated by the dash arrows in FIG. 8. The output signal 870 of an PE 810 may be sent to many other PEs 810 (and possibly back to itself) as input signals via the interconnections between PEs 810. In some embodiments, the output signal 870 of an PE 810 may incorporate the output signals of one or more other PEs 810 through an accumulate operation of the PE 810 and generates an internal partial sum of the PE array. More details about the PEs 810 are described below in conjunction with FIG. 8B.

In the embodiments of FIG. 8, the PEs 810 are arranged into columns 805 (individually referred to as “column 805”). The input and weights of the layer may be distributed to the PEs 810 based on the columns 805. Each column 805 has a column buffer 820. The column buffer 820 stores data provided to the PEs 810 in the column 805 for a short amount of time. The column buffer 820 may also store data output by the last PE 810 in the column 805. The output of the last PE 810 may be a sum of the MAC operations of all the PEs 810 in the column 805, which is a column-level internal partial sum of the PE array 800. In other embodiments, input and weights may be distributed to the PEs 810 based on rows in the PE array 800. The PE array 800 may include row buffers in lieu of column buffers 820. A row buffer may store input signals of the PEs in the corresponding row and may also store a row-level internal partial sum of the PE array 800.

As shown in FIG. 8, each column buffer 820 is associated with a load 830 and a drain 840. The data provided to the column 805 is transmitted to the column buffer 820 through the load 830, e.g., through upper memory hierarchies, e.g., the local memory 410 in FIG. 4. The data generated by the column 805 is extracted from the column buffers 820 through the drain 840. A column buffer 820 may be a part of the datastore 430 in FIG.4. In some embodiments, data extracted from a column buffer 820 is sent to upper memory hierarchies, e.g., the local memory 410 in FIG. 4, through the drain operation. In some embodiments, the drain operation does not start until all the PEs 810 in the column 805 has finished their MAC operations. Even though not shown in FIG. 8, one or more columns 805 may be associated with an external adder assembly.

Example PE

FIG. 9 is a block diagram of a PE 900, in accordance with various embodiments. The PE 900 may be an embodiment of a PE in the PE array 440 in FIG. 4 or an embodiment of the PE 810 in FIG. 8. The PE 900 includes input register files 910 (individually referred to as “input register file 910”), weight registers file 920 (individually referred to as “weight register file 920”), multipliers 930 (individually referred to as “multiplier 930”), shifters 935 (individually referred to as “shifter 935”), a first adder assembly 940, a second adder assembly 945, and an output register file 960. In other embodiments, the PE 900 may include fewer, more, or different components. For example, the PE 900 may include multiple output register files 960. As another example, the PE 900 may include a single input register file 910, weight register file 920, multiplier 930, or shifter 935. As yet another example, the PE 900 may not include the first adder assembly 940 or the second adder assembly 945.

The input register files 910 temporarily store input operands for MAC operations by the PE 900. In some embodiments, an input register file 910 may store a single input operand at a time. In other embodiments, an input register file 910 may store multiple input operand or a portion of an input operand at a time. An input operand includes a plurality of input elements (i.e., input elements) in an input tensor. The input elements of an input operand may be stored sequentially in the input register file 910 so the input elements can be processed sequentially. In some embodiments, each input element in the input operand may be from a different input channel of the input tensor. The input operand may include an input element from each of the input channels of the input tensor, and the number of input elements in an input operand may equal the number of the input channels. The input elements in an input operand may have the same XY coordinates, which may be used as the XY coordinates of the input operand. For instance, all the input elements of an input operand may be X0Y0, X0Y1, X1Y1, etc. In some embodiments, one or more input register files 910 may store nonzero-valued elements of an input operand and not store zero-valued elements of the input operand.

The weight register file 920 temporarily stores weight operands for MAC operations by the PE 900. The weight operands include weights in the filters of the DNN layer. In some embodiments, the weight register file 920 may store a single weight operand at a time. other embodiments, an input register file 910 may store multiple weight operands or a portion of a weight operand at a time. A weight operand may include a plurality of weights. The weights of a weight operand may be stored sequentially in the weight register file 920 so the weight can be processed sequentially. In some embodiments, for a multiplication operation that involves a weight operand and an input operand, each weight in the weight operand may correspond to an input element of the input operand. The number of weights in the weight operand may equal the number of the input elements in the input operand.

In some embodiments, one or more weight register files 920 may store nonzero-valued weight(s) of a weight operand and not store zero-valued weight(s) of the weight operand. Additionally or alternatively, one or more weight register files 920 may store weights that have compressed in a hybrid matter. For instance, the one or more weight register files 920 may store one or more integers and one or more exponents of power of two values for a weight operand.

In some embodiments, a weight register file 920 may be the same or similar as an input register file 910, e.g., having the same size, etc. The PE 900 may include a plurality of register files, some of which are designated as the input register files 910 for storing input operands, some of which are designated as the weight register files 920 for storing weight operands, and some of which are designated as the output register file 960 for storing output operands. In other embodiments, register files in the PE 900 may be designated for other purposes, e.g., for storing scale operands used in elementwise add operations, etc. The designation of the register files may be controlled by the controlling module 340.

The multipliers 930 perform multiplication operations on activations and weights. A multiplier 930 may perform a sequence of multiplication operations and generates a sequence of products. Each multiplication operation in the sequence includes multiplying an activation with the corresponding weight. In some embodiments, a position (or index) of the activation in the input operand matches the position (or index) of the weight in the weight operand. For instance, the first multiplication operation is a multiplication of the first activation in the input operand and the first weight in the weight operand, the second multiplication operation is a multiplication of the second activation in the input operand and the second weight in the weight operand, the third multiplication operation is a multiplication of the third activation in the input operand and the third weight in the weight operand, and so on. The activation and weight in the same multiplication operation may correspond to the same input channel, and their product may also correspond to the same input channel.

Multiple multipliers 930 may perform multiplication operations simultaneously. These multiplication operations may be referred to as a round of multiplication operations. In a round of multiplication operations by the multipliers 930, each of the multipliers 930 may use a different set of activation(s) and a different set of weight(s). The different sets of activation(s) or sets of weight(s) may be stored in different register files of the PE 900. For instance, a first multiplier 930 uses a first set of activation(s) (e.g., stored in a first input register file 910) and a first set of weight(s) (e.g., stored in a first weight register file 920), versus a second multiplier 930 uses a second set of activation(s) (e.g., stored in a second input register file 910) and a second set of weight(s) (e.g., stored in a second weight register file 920), a third multiplier 930 uses a third set of activation(s) (e.g., stored in a third input register file 910) and a third set of weight(s) (e.g., stored in a third weight register file 920), and so on. For an individual multiplier 930, the round of multiplication operations may include a plurality of cycles. A cycle includes a multiplication operation on an activation and a weight.

The multipliers 930 may perform multiple rounds of multiplication operations. A multiplier 930 may use the same weight(s) but different activations in different rounds. For instance, the multiplier 930 performs a sequence of multiplication operations on a first set of activation(s) stored in a first input register file in a first round, versus a second set of activation(s) stored in a second input register file in a second round. In the second round, a different multiplier 930 may use the first set of activation(s) and a different set of weight(s) to perform another sequence of multiplication operations. That way, the first set of activation(s) can be reused in the second round. The first set of activation(s) may be further reused in additional rounds, e.g., by additional multipliers 930.

The shifters 935 perform shift operations on activations and exponents of power of two values quantized from weights. A shifter may be an arithmetic shifter, a logic shifter, a barrel shifter, or other types of shifters. The shifters 935 may be left shifters. A shifter 935 may perform a sequence of shift operations and generates a sequence of products, each of which is a product of an activation and the corresponding weight. Each shift operation in the sequence includes shifting an activation left by the exponent of the power of two value quantized from the corresponding weight. The output of the shift operation may be the product of multiplying the activation with the power of two value. In some embodiments, a position (or index) of the activation in the input operand matches the position (or index) of the weight in the weight operand. For instance, the first shift operation is for the first activation in the input operand and the first weight in the weight operand, the second shift operation is for the second activation in the input operand and the second weight in the weight operand, the third shift operation is for the third activation in the input operand and the third weight in the weight operand, and so on. The activation and weight for the same shift operation may correspond to the same input channel, and their product may also correspond to the same input channel.

Multiple shifters 935 may perform shift operations simultaneously. These shift operations may be referred to as a round of shift operations. In a round of shift operations by the shifters 935, each of the shifters 935 may use a different set of activation(s) and a different set of weight(s). The different sets of activation(s) or sets of weight(s) may be stored in different register files of the PE 900. For instance, a first shifter 935 uses a first set of activation(s) (e.g., stored in a first input register file 910) and a first set of weight(s) (e.g., stored in a first weight register file 920), versus a second shifter 935 uses a second set of activation(s) (e.g., stored in a second input register file 910) and a second set of weight(s) (e.g., stored in a second weight register file 920), a third shifter 935 uses a third set of activation(s) (e.g., stored in a third input register file 910) and a third set of weight(s) (e.g., stored in a third weight register file 920), and so on. For an individual shifter 935, the round of shift operations may include a plurality of cycles. A cycle includes a shift operation on an activation and a weight.

The shifters 935 may perform multiple rounds of shift operations. A shifter 935 may use the same weight(s) but different activations in different rounds. For instance, the shifter 935 performs a sequence of shift operations on a first set of activation(s) stored in a first input register file in a first round, versus a second set of activation(s) stored in a second input register file in a second round. In the second round, a different shifter 935 may use the first set of activation(s) and a different set of weight(s) to perform another sequence of shift operations. That way, the first set of activation(s) can be reused in the second round. The first set of activation(s) may be further reused in additional rounds, e.g., by additional shifters 935.

The first adder assembly 940 includes one or more adders inside the PE 900 (i.e., internal adders). The first adder assembly 940 is coupled to the multipliers 930. The first adder assembly 940 may perform accumulation operations on two or more products operands from multipliers 930 and generate a multiplication sum. The first adder assembly 940 may include one or more compressors (e.g., 3-2 compressors that receive three inputs and generates two outputs), ripple-carry adders, prefix adders, other types of adders, or some combination thereof.

In some embodiments, the internal adders may be arranged in a sequence of tiers. A tier includes one or more internal adders. For the first tier of the first adder assembly 940, an internal adder may receive outputs from two or more multipliers 930 and generate a sum in an individual accumulation cycle. For the other tier(s) of the first adder assembly 940, an internal adder in a tier may sum two or more outputs from the precedent tier in the sequence. Each of these outputs may be generated by a different internal adder in the precedent tier. A ratio of the number of internal adders in a tier to the number of internal adders in a subsequent tier may be 2:1. In some embodiments, the last tier of the first adder assembly 940 may include a single internal adder, which generates a multiplication partial sum.

The second adder assembly 945 includes one or more other adders inside the PE 900, i.e., other internal adders. The second adder assembly 945 is coupled to the shifters 935. The second adder assembly 945 may perform accumulation operations on two or more outputs from shifters 935 and generate a shift sum. The first adder assembly 940 may include one or more compressors (e.g., 3-2 compressors that receive three inputs and generates two outputs), ripple-carry adders, prefix adders, other types of adders, or some combination thereof.

In some embodiments, the internal adders in the second adder assembly 945 may be arranged in a sequence of tiers. A tier includes one or more internal adders. For the first tier of the second adder assembly 945, an internal adder may receive outputs from two or more shifters 935 and generate a sum of the outputs in an individual accumulation cycle. For the other tier(s) of the second adder assembly 945, an internal adder in a tier sums two or more outputs from the precedent tier in the sequence. Each of these outputs may be generated by a different internal adder in the precedent tier. A ratio of the number of internal adders in a tier to the number of internal adders in a subsequent tier may be 2:1. In some embodiments, the last tier of the second adder assembly 945 may include a single internal adder, which generates a shift partial sum.

The accumulator 950 may sum the multiplication partial sum with the shift partial sum to generate a partial sum of the PE 900. In some embodiments, the accumulator 950 may be an adder. Even though the accumulator 950 is a separate component of the PE 900 from the first adder assembly 940 and the second adder assembly 945 in FIG. 9, the accumulator 950 may be implemented in the first adder assembly 940 or the second internal adder assembly in other embodiments. For instance, the accumulator 950 may be an adder in the last tier of an internal adder tree in the first adder assembly 940 or the second internal adder assembly.

The output register file 960 stores one or more output activations computed by the PE 900. In some embodiments, the output register file 960 may store an output activation at a time. In other embodiments, the output register file 960 may store multiple output activation at a time. An output activation may be the partial sum of the PE 900 that is computed by the accumulator 950. In some embodiments, the accumulator 950 may receive one or more partial sums of one or more other PEs and accumulate the partial sum of the PE 900 with the one or more partial sums. The sum of the partial sum of the PE 900 with the one or more partial sums may be a partial sum for a group of PEs, such as a PE column (e.g., PE column 805).

FIG. 10 illustrates an example PE 1000 capable of hybrid MAC operations, in accordance with various embodiments. The PE 1000 may be an embodiment of the PE 900 in FIG. 9. The PE 1000 includes an input register file 1010, a weight register file 1020, four multipliers 1030 (individually referred to as “multiplier 1030”), four shifters 1040 (individually referred to as “shifter 1040”), an accumulator 1050, and an output register file 1060. In other embodiments, the PE 1000 may include fewer, more, or different components. The input register file 1010 may be an embodiment of the input register file 910 in FIG. 9. The weight register file 1020 may be an embodiment of the weight register file 920. A multiplier 1030 may be an embodiment of the multiplier 930. A shifter 1040 may be an embodiment of the shifter 935. The accumulator 1050 may be an embodiment of the accumulator 950. The output register file 1060 may be an embodiment of the output register file 960.

Each multiplier 1030 receives an activation from the input register file 1010 and a weight having an integer value from the weight register file 1020. The multipliers 1030 may receive different activation-weight pairs. The integer value of the weight may be generated by quantizing the original value of the weight, which may be determined by training the DNN. The integer value may have one byte. Each multiplier 1030 multiplies the activation with the integer value. In some embodiments, the multiplier 1030 may be an integer multiplier. The outputs of the multipliers 1030 are transmitted to the accumulator 1050.

Each shifter 1040 receives an activation from the input register file 1010 and an exponent of a power of two value from the weight register file 1020. The in power of two value may be generated by quantizing the original value of a weight, which may be determined by training the DNN. The shifters 1040 may receive different activation-weight pairs. Each shifter 1040 shifts the bits in the activation left by the exponent. In some embodiments, the shifter 1040 may be an arithmetic shifter. The outputs of the shifters 1040 are transmitted to the accumulator 1050.

A bit in a compression bitmap may be used to determine whether to send an activation-weight pair to a multiplier 1030 or a shifter 1040. For instance, the determination may be made based on the value of a bit that corresponds to the weight in the activation-weight pair. In embodiments where the value of the bit is one, the activation-weight pair may be sent to a multiplier 1030. In embodiments where the value of the bit is zero, the activation-weight pair may be sent to a shifter 1040. In some embodiments, the computation in a shifter 1040 may be faster than a computation in a multiplier 1030. A shifter 1040 have a simpler structure and smaller gate depth than a multiplier 1030. The length of the path through the shifters 1040 may be shorter than the length of the path through the multipliers 1030. In some embodiments, the complexity of one or more shifters 1040 may be further reduced by limiting the range of shifts, e.g., in embodiments where larger shifts are rare.

The accumulator 1050 accumulates the outputs of the multipliers 1030 and shifters 1040 and generates a partial sum of the PE 1000. The partial sum may be stored in the output register file 1060. In some embodiments, the accumulator 1050 may receive one or more partial sums of one or more other PEs and accumulate the partial sum of the PE 1000 with the one or more partial sums. The sum of the partial sum of the PE 1000 with the one or more partial sums may be a partial sum for a group of PEs, such as a PE column (e.g., PE column 805). The partial sum of the group of PEs may be stored in the output register file 1060. In some embodiments, the partial sum of the group of PEs may be further accumulated with one or more additional partial sums, by the PE 1000 or another PE.

Even though FIG. 10 shows four multipliers 1030 and four shifters 1040, a PE may include a different number of multipliers 1030 or a different number of shifters 1040. The total number of multipliers 1030 and shifters 1040 may be fewer or more than eight. Also, the ratio of the number of multipliers 1030 to the number of shifters 1040 in a PE may be different.

FIG. 11 illustrates another example PE 1100 capable of hybrid MAC operations, in accordance with various embodiments. The PE 1100 may be an embodiment of the PE 900 in FIG. 9. The PE 1100 includes an input register file 1110, a weight register file 1120, two multipliers 1130 (individually referred to as “multiplier 1130”), six shifters 1140 (individually referred to as “shifter 1140”), an accumulator 1150, and an output register file 1160. In other embodiments, the PE 1100 may include fewer, more, or different components. The input register file 1110 may be an embodiment of the input register file 910 in FIG. 9. The weight register file 1120 may be an embodiment of the weight register file 920. A multiplier 1130 may be an embodiment of the multiplier 930. A shifter 1140 may be an embodiment of the shifter 935. The accumulator 1150 may be an embodiment of the accumulator 950. The output register file 1160 may be an embodiment of the output register file 960.

Each multiplier 1130 receives an activation from the input register file 1110 and a weight having an integer value from the weight register file 1120. The multipliers 1130 may receive different activation-weight pairs. The integer value of the weight may be generated by quantizing the original value of the weight, which may be determined by training the DNN. The integer value may have one byte. Each multiplier 1130 multiplies the activation with the integer value. In some embodiments, the multiplier 1130 may be an integer multiplier. The outputs of the multipliers 1130 are transmitted to the accumulator 1150.

Each shifter 1140 receives an activation from the input register file 1110 and an exponent of a power of two value from the weight register file 1120. The in power of two value may be generated by quantizing the original value of a weight, which may be determined by training the DNN. The shifters 1140 may receive different activation-weight pairs. Each shifter 1140 shifts the bits in the activation left by the exponent. In some embodiments, the shifter 1140 may be an arithmetic shifter. The outputs of the shifters 1140 are transmitted to the accumulator 1150.

A bit in a compression bitmap may be used to determine whether to send an activation-weight pair to a multiplier 1130 or a shifter 1140. For instance, the determination may be made based on the value of a bit that corresponds to the weight in the activation-weight pair. In embodiments where the value of the bit is one, the activation-weight pair may be sent to a multiplier 1130. In embodiments where the value of the bit is zero, the activation-weight pair may be sent to a shifter 1140. In some embodiments, the computation in a shifter 1140 may be faster than a computation in a multiplier 1130. A shifter 1140 have a simpler structure and smaller gate depth than a multiplier 1130. The length of the path through the shifters 1140 may be shorter than the length of the path through the multipliers 1130. In some embodiments, the complexity of one or more shifters 1140 may be further reduced by limiting the range of shifts, e.g., in embodiments where larger shifts are rare.

The accumulator 1150 accumulates the outputs of the multipliers 1130 and shifters 1140 and generates a partial sum of the PE 1100. The partial sum may be stored in the output register file 1160. In some embodiments, the accumulator 1150 may receive one or more partial sums of one or more other PEs and accumulate the partial sum of the PE 1100 with the one or more partial sums. The sum of the partial sum of the PE 1100 with the one or more partial sums may be a partial sum for a group of PEs, such as a PE column (e.g., PE column 805). The partial sum of the group of PEs may be stored in the output register file 1160. In some embodiments, the partial sum of the group of PEs may be further accumulated with one or more additional partial sums, by the PE 1100 or another PE.

The number of multipliers or shifters in a PE may not have to fixed. In some embodiments, the number of multipliers or shifters in a PE may be flexible. FIG. 12 illustrates a configurable PE 1200 capable of hybrid MAC operations, in accordance with various embodiments. The PE 1200 may be an embodiment of the PE 900 in FIG. 9. The PE 1200 includes an input register file 1210, a weight register file 1220, three multiplier-shifter pairs 1270, three selectors 1280, an accumulator 1250, and an output register file 1260. Each multiplier-shifter pair 1270 includes a multiplier 1230 and a shifter 1240. The multiplier-shifter pairs 1270 are respectively coupled to the selectors 1280. In other embodiments, the PE 1200 may include fewer, more, or different components. The input register file 1210 may be an embodiment of the input register file 910 in FIG. 9. The weight register file 1220 may be an embodiment of the weight register file 920. A multiplier 1230 may be an embodiment of the multiplier 930, the multiplier 1030, or the multiplier 1130. A shifter 1240 may be an embodiment of the shifter 935, the shifter 1040, or the shifter 1140. The accumulator 1250 may be an embodiment of the accumulator 950. The output register file 1260 may be an embodiment of the output register file 960.

Each multiplier-shifter pair 1270 receives an activation from the input register file 1210 and a data element from the weight register file 1220. The selector 1280 receives a bit from the weight register file 1220. The bit is in a compression bitmap and corresponds to the data element from the weight register file 1220. The selector 1280 may transmit the activation and data element to the multiplier 1230 or the shifter 1240 in the multiplier-shifter pair 1270 based on the value of the bit. In embodiments where the value of the bit is one, which indicates that the data element is an integer that is generated from quantizing a weight, the activation and data element are sent to the multiplier 1230. The multiplier 1230 multiplies the activation with the data element. In embodiments where the value of the bit is zero, which indicates that the data element is an exponent of a power of two value that is generated from quantizing a weight, the activation and data element are sent to the shifter 1240. The shifter 1240 shifts the bits in the activation left by the exponent.

The number of multiplier(s) 1230 or shifter(s) 1240 that are active in a computation cycle of the PE 1200 can therefore be dynamic. The number can change based on the number of integers or power of two values in the weight subtensor processed by the PE 1200. Even though FIG. 12 shows three multiplier-shifter pairs 1270 and three selectors 1280, a PE may include a different number of multiplier-shifter pair(s) 1270 or a different number of selectors 1280. In some embodiments, a PE may be partially configurable. For instance, the PE may include one or more multiplier-shifter pairs and one or more selectors in addition to separate multipliers (e.g., the multipliers 1030 or 1130) or separate shifters (e.g., the shifters 1040 or 1140).

The accumulator 1250 accumulates the outputs of the multiplier-shifter pairs 1270 and generates a partial sum of the PE 1200. The partial sum may be stored in the output register file 1260. In some embodiments, the accumulator 1250 may receive one or more partial sums of one or more other PEs and accumulate the partial sum of the PE 1200 with the one or more partial sums. The sum of the partial sum of the PE 1200 with the one or more partial sums may be a partial sum for a group of PEs, such as a PE column (e.g., PE column 805). The partial sum of the group of PEs may be stored in the output register file 1260. In some embodiments, the partial sum of the group of PEs may be further accumulated with one or more additional partial sums, by the PE 1200 or another PE.

FIG. 13 illustrates a PE 1300 with a compressor 1370 and an adder tree 1375, in accordance with various embodiments. The PE 1300 may be an embodiment of the PE 900 in FIG. 9. The PE 1300 also includes an input register file 1310, a weight register file 1320, four multipliers 1330 (individually referred to as “multiplier 1330”), four shifters 1340A-1340D (collectively referred to as “shifters 1340” or “shifter 1340”), an accumulator 1350, and an output register file 1360. In other embodiments, the PE 1300 may include fewer, more, or different components. The input register file 1310 may be an embodiment of the input register file 910 in FIG. 9. The weight register file 1320 may be an embodiment of the weight register file 920. A multiplier 1330 may be an embodiment of the multiplier 930. A shifter 1340 may be an embodiment of the shifter 935. The accumulator 1350 may be an embodiment of the accumulator 950. The output register file 1360 may be an embodiment of the output register file 960. The compressor 1370 may be an embodiment of the first adder assembly 940. The adder tree 1375 may be an embodiment of the second adder assembly 945.

Each multiplier 1330 receives an activation from the input register file 1310 and a weight having an integer value from the weight register file 1320. The multipliers 1330 may receive different activation-weight pairs. The integer value of the weight may be generated by quantizing the original value of the weight, which may be determined by training the DNN. The integer value may have one byte. Each multiplier 1330 multiplies the activation with the integer value. In some embodiments, the multiplier 1330 may be an integer multiplier. The outputs of the multipliers 1330 are transmitted to the accumulator 1350.

Each shifter 1340 receives an activation from the input register file 1310 and an exponent of a power of two value from the weight register file 1320. The in power of two value may be generated by quantizing the original value of a weight, which may be determined by training the DNN. The shifters 1340 may receive different activation-weight pairs. Each shifter 1340 shifts the bits in the activation left by the exponent. In some embodiments, the shifter 1340 may be an arithmetic shifter. The outputs of the shifters 1340 are transmitted to the accumulator 1350.

A bit in a compression bitmap may be used to determine whether to send an activation-weight pair to a multiplier 1330 or a shifter 1340. For instance, the determination may be made based on the value of a bit that corresponds to the weight in the activation-weight pair. In embodiments where the value of the bit is one, the activation-weight pair may be sent to a multiplier 1330. In embodiments where the value of the bit is zero, the activation-weight pair may be sent to a shifter 1340. In some embodiments, the computation in a shifter 1340 may be faster than a computation in a multiplier 1330. A shifter 1340 have a simpler structure and smaller gate depth than a multiplier 1330. The length of the path through the shifters 1340 may be shorter than the length of the path through the multipliers 1330. In some embodiments, the complexity of one or more shifters 1340 may be further reduced by limiting the range of shifts, e.g., in embodiments where larger shifts are rare.

The compressor 1370 receives outputs of the multipliers 1330. The compressor 1370 may be an adder compressor that compresses N inputs into two outputs, where N is an integer that is greater than two. In some embodiments, N may be 3, 4, 5, etc. In the embodiments of FIG. 13, the inputs of the compressor 1370 are the outputs of the multipliers 1330. The compressor 1370 outputs the sum of the outputs of the multipliers 1330, which is the partial sum of the multipliers 1330. Even though FIG. 13 shows one compressor 1370, the PE 1300 may include more than one compressor 1370 coupled to the multipliers 1330 to compute the sum of the outputs of the multipliers 1330. Also, the compressor 1370 may be coupled to a different number of multipliers 1330.

The adder tree 1375 receives outputs of the shifters 1340. As shown in FIG. 13, the adder tree 1375 includes two tiers of adders: the first tier includes two adders 1380A and 1380B, and the second tier includes one adder 1390. The adder 1380A receives outputs of the shifters 1340A and 1340B and generates a sum of the outputs. The adder 1380B receives outputs of the shifters 1340C and 1340D and generates a sum of the outputs. The adder 1390 sums outputs of the adders 1380A and 1380B and generates the partial sum of the shifters 1340. The number of adders in the adder tree 1375 may depend on the number of shifters 1340 in the PE 1300. Even though FIG. 13 shows four shifters 1340, the PE 1300 may include a different number of shifters 1340 and a different number of adders in the adder tree 1375. An adder (e.g., the adder 1380A, 1380B, or 1390) in the adder tree may be a ripple-carry adder.

The adders in the adder tree 1375 may be slower than the compressor 1370, i.e., the computation speed of the adders is lower than the computation speed of the compressor 1370. Also, the path through the adder tree 1375 may be longer than the path through the compressor 1370. An advantage of the adder tree 1375 is that it can be smaller than the compressor 1370. For instance, the adder tree 1375 may have fewer gates per unit function than the compressor 1370. As the shifters 1340 can be faster than the multipliers 1330, the overall speed of the paths (i.e., a first path including the multipliers 1330 and the compressor 1370, and a second path including the shifters 1340 and the adder tree 1375) can be the same or substantially similar. In some cases, the adder tree 1375 could be implemented using a combination of one or more adders (e.g., ripple-carry adders) and one or more compressors. In some cases, one or both of the outputs of the compressor 1370 and the adder tree 1375 may be in redundant form, in which case addition adder(s) or compressor(s) may be used to prepare two inputs for the accumulator 1350.

The accumulator 1350 accumulates the outputs of the compressor 1370 and the adder tree 1375 and generates a partial sum of the PE 1300. The partial sum may be stored in the output register file 1360. In some embodiments, the accumulator 1350 may receive one or more partial sums of one or more other PEs and accumulate the partial sum of the PE 1300 with the one or more partial sums. The sum of the partial sum of the PE 1300 with the one or more partial sums may be a partial sum for a group of PEs, such as a PE column (e.g., PE column 805). The partial sum of the group of PEs may be stored in the output register file 1360. In some embodiments, the partial sum of the group of PEs may be further accumulated with one or more additional partial sums, by the PE 1300 or another PE.

Example Method of Performing Hybrid MAC Operation

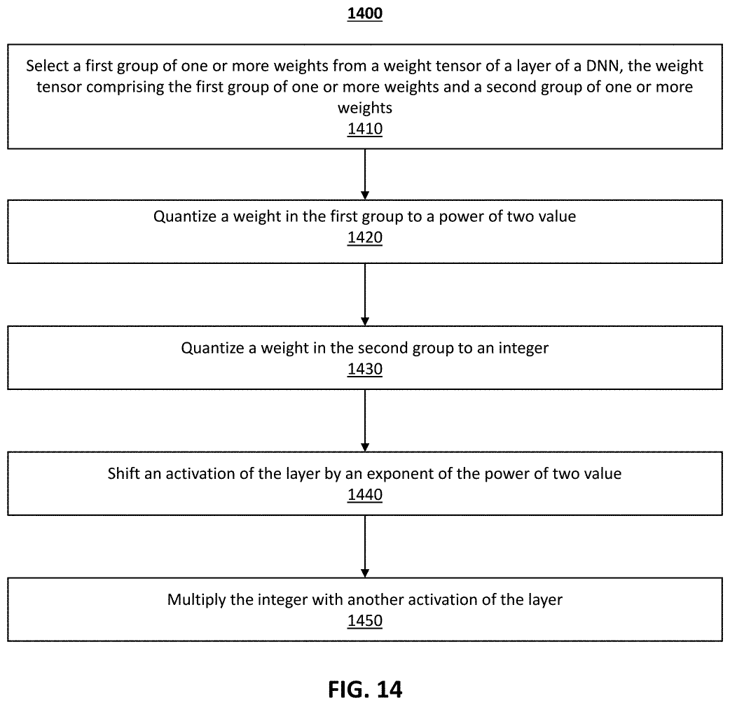

FIG. 14 is a flowchart showing a method 1400 of performing a hybrid MAC operation, in accordance with various embodiments. The method 1400 may be performed by the compute block 400 in FIG. 4. Although the method 1400 is described with reference to the flowchart illustrated in FIG. 14, many other methods for performing hybrid MAC operations may alternatively be used. For example, the order of execution of the steps in FIG. 14 may be changed. As another example, some of the steps may be changed, eliminated, or combined.

The compute block 400 selects 1410 a first group of one or more weights from a weight tensor of a layer of the DNN. The weight tensor comprises the first group of one or more weights and a second group of one or more weights. The layer may be a convolutional layer, such as one of the convolutional layers 110 in FIG. 1. The weight tensor may be a subtensor of the whole weight tensor of the layer. The whole weight tensor may be a four-dimensional tensor. The weight tensor may be a two-dimensional or three-dimensional tensor. In some embodiments, the weight tensor comprises a plurality of weights arranged in one or more rows and one or more columns. The number of weights in a row of the weight tensor is equal to the number of channels in the IFM of the layer. The number of weights in a column of the weight tensor is equal to the number of channels in the output feature map of the layer.

In some embodiments, the compute block 400 selects a same number of weight or weights from each respective row of the weight tensor. In some embodiments, the compute block 400 selects the first group of one or more weights from the weight tensor based on a predetermined partition parameter. The partition parameter indicating a ratio of the number of weight or weights in the first group to a number of weight or weights in the second group.

In some embodiments, the compute block 400 selects the first group of one or more weights from the weight tensor by minimizing a difference between the weight tensor and a tensor comprising one or more integers and one or more power or two values. The one or more integers are generated by quantizing the one or more weights in the first group. The one or more power or two values are generated by quantizing the one or more weights in the second group.

The compute block 400 quantizes 1420 a weight in the first group to a power of two value. In some embodiments, the divides a whole weight tensor of the layer into the weight tensor and an additional weight tensor. The compute block 400 selects a third group of one or more weights from the additional weight tensor and quantizes each respective weight in the third group to a power of two value. A ratio of the number of weight or weights in the first group to the number of weights in the weight tensor is different from a ratio of the number of weight or weights in the third group to the number of weights in the additional weight tensor.

The compute block 400 quantizes 1430 a weight in the second group to an integer. In some me bailments, the compute block 400 stores, in a memory, the exponent of the power of two value in lieu of the weight in the first group. The compute block 400 stores, in the memory, the integer in lieu of the weight in the second group. The memory space needed to store the integer and the exponent may be smaller than the memory space needed to store the weights.

The compute block 400 shifts 1440 an activation of the layer by an exponent of the power of two value. The compute block 400 may include a shifter that can shift the activation by the exponent. The compute block 400 may include multiple shifters that can shift activations by exponents of power of two values that are generated by quantizing weights. The shifters may be coupled to an accumulator that accumulates the outputs of the shifters.

The compute block 400 multiplies 1450 the integer with another activation of the layer. The compute block 400 may include a multiplier that can multiple the other activation with the integer. The compute block 400 may include multiple multipliers that can multiple activations with integers that are generated by quantizing weights. The multipliers may be coupled to an accumulator that accumulates the outputs of the multipliers. The accumulator coupled to the multipliers may have a faster computation speed than the accumulator coupled to the shifters.

In some embodiments, the compute block 400 generates a bitmap for the weight tensor. The bitmap comprises a plurality of bits. Each bit corresponds to a weight in the weight tensor and indicates whether the weight is quantized to an integer or a power of two value. For instance, a bit having a value of zero indicates that a corresponding weight is quantized to a power of two value. A bit having a value of one indicates that a corresponding weight is quantized to an integer. In some embodiments, the compute block transmits, based on the bitmap, the first group of one or more weights from a memory to one or more shifters. Also, the compute block transmits, based on the bitmap, the second group of one or more weights from the memory to one or more multipliers.

Example Computing Device

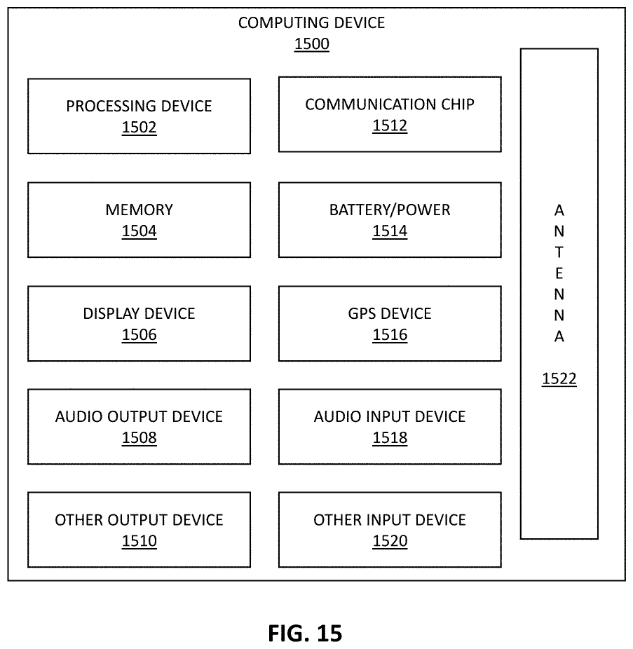

FIG. 15 is a block diagram of an example computing device 1500, in accordance with various embodiments. In some embodiments, the computing device 1500 may be used as at least part of the DNN accelerator 300 in FIG. 3. A number of components are illustrated in FIG. 15 as included in the computing device 1500, but any one or more of these components may be omitted or duplicated, as suitable for the application. In some embodiments, some or all of the components included in the computing device 1500 may be attached to one or more motherboards. In some embodiments, some or all of these components are fabricated onto a single system on a chip (SoC) die. Additionally, in various embodiments, the computing device 1500 may not include one or more of the components illustrated in FIG. 15, but the computing device 1500 may include interface circuitry for coupling to the one or more components. For example, the computing device 1500 may not include a display device 1506, but may include display device interface circuitry (e.g., a connector and driver circuitry) to which a display device 1506 may be coupled. In another set of examples, the computing device 1500 may not include an audio input device 1518 or an audio output device 1508, but may include audio input or output device interface circuitry (e.g., connectors and supporting circuitry) to which an audio input device 1518 or audio output device 1508 may be coupled.

The computing device 1500 may include a processing device 1502 (e.g., one or more processing devices). The processing device 1502 processes electronic data from registers and/or memory to transform that electronic data into other electronic data that may be stored in registers and/or memory. The computing device 1500 may include a memory 1504, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1504 may include memory that shares a die with the processing device 1502. In some embodiments, the memory 1504 includes one or more non-transitory computer-readable media storing instructions executable for perform hybrid MAC operations in DNNs, e.g., the method 1400 described above in conjunction with FIG. 14 or some operations performed by the compute block 400 or the weight compressing module 420 described above in conjunction with FIG. 4. The instructions stored in the one or more non-transitory computer-readable media may be executed by the processing device 1502.

In some embodiments, the computing device 1500 may include a communication chip 1512 (e.g., one or more communication chips). For example, the communication chip 1512 may be configured for managing wireless communications for the transfer of data to and from the computing device 1500. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 1512 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1512 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1512 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1512 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1512 may operate in accordance with other wireless protocols in other embodiments. The computing device 1500 may include an antenna 1522 to facilitate wireless communications and/or to receive other wireless communications (such as AM or FM radio transmissions).

In some embodiments, the communication chip 1512 may manage wired communications, such as electrical, optical, or any other suitable communication protocols (e.g., the Ethernet). As noted above, the communication chip 1512 may include multiple communication chips. For instance, a first communication chip 1512 may be dedicated to shorter-range wireless communications such as Wi-Fi or Bluetooth, and a second communication chip 1512 may be dedicated to longer-range wireless communications such as global positioning system (GPS), EDGE, GPRS, CDMA, WiMAX, LTE, EV-DO, or others. In some embodiments, a first communication chip 1512 may be dedicated to wireless communications, and a second communication chip 1512 may be dedicated to wired communications.

The computing device 1500 may include battery/power circuitry 1514. The battery/power circuitry 1514 may include one or more energy storage devices (e.g., batteries or capacitors) and/or circuitry for coupling components of the computing device 1500 to an energy source separate from the computing device 1500 (e.g., AC line power).

The computing device 1500 may include a display device 1506 (or corresponding interface circuitry, as discussed above). The display device 1506 may include any visual indicators, such as a heads-up display, a computer monitor, a projector, a touchscreen display, a liquid crystal display (LCD), a light-emitting diode display, or a flat panel display, for example.

The computing device 1500 may include an audio output device 1508 (or corresponding interface circuitry, as discussed above). The audio output device 1508 may include any device that generates an audible indicator, such as speakers, headsets, or earbuds, for example.

The computing device 1500 may include an audio input device 1518 (or corresponding interface circuitry, as discussed above). The audio input device 1518 may include any device that generates a signal representative of a sound, such as microphones, microphone arrays, or digital instruments (e.g., instruments having a musical instrument digital interface (MIDI) output).

The computing device 1500 may include a GPS device 1516 (or corresponding interface circuitry, as discussed above). The GPS device 1516 may be in communication with a satellite-based system and may receive a location of the computing device 1500, as known in the art.

The computing device 1500 may include another output device 1510 (or corresponding interface circuitry, as discussed above). Examples of the other output device 1510 may include an audio codec, a video codec, a printer, a wired or wireless transmitter for providing information to other devices, or an additional storage device.

The computing device 1500 may include another input device 1520 (or corresponding interface circuitry, as discussed above). Examples of the other input device 1520 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1500 may have any desired form factor, such as a handheld or mobile computer system (e.g., a cell phone, a smart phone, a mobile internet device, a music player, a tablet computer, a laptop computer, a netbook computer, an ultrabook computer, a PDA (personal digital assistant), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1500 may be any other electronic device that processes data.

### SELECTED EXAMPLES

The following paragraphs provide various examples of the embodiments disclosed herein.

Example 1 provides a method of executing a DNN, including selecting a first group of one or more weights from a weight tensor of a layer of the DNN, the weight tensor including the first group of one or more weights and a second group of one or more weights; quantizing a weight in the first group to a power of two value; quantizing a weight in the second group to an integer; shifting an activation of the layer by an exponent of the power of two value; and multiplying the integer with another activation of the layer.

Example 2 provides the method of example 1, where the weight tensor includes a plurality of weights arranged in one or more rows and one or more columns, a number of weights in a row of the weight tensor is equal to a number of channels in an IFM of the layer, and a number of weights in a column of the weight tensor is equal to a number of channels in an output feature map of the layer.

Example 3 provides the method of example 2, where selecting the first group of one or more weights from the weight tensor includes selecting a same number of weight or weights from each respective row of the weight tensor.

Example 4 provides the method of any of the preceding examples, where selecting the first group of one or more weights from the weight tensor includes selecting the first group of one or more weights from the weight tensor based on a predetermined partition parameter, the partition parameter indicating a ratio of a number of weight or weights in the first group to a total number of weights in the weight tensor.

Example 5 provides the method of any of the preceding examples, where selecting the first group of one or more weights from the weight tensor includes selecting the first group of one or more weights from the weight tensor by minimizing a difference between the weight tensor and a tensor including one or more integers and one or more power or two values, where the one or more integers are generated by quantizing the one or more weights in the first group, and the one or more power or two values are generated by quantizing the one or more weights in the second group.

Example 6 provides the method of any of the preceding examples, further including dividing a whole weight tensor of the layer into the weight tensor and an additional weight tensor; selecting a third group of one or more weights from the additional weight tensor; and quantizing each respective weight in the third group to a power of two value, where a ratio of a number of weight or weights in the first group to a number of weights in the weight tensor is different from a ratio of a number of weight or weights in the third group to a number of weights in the additional weight tensor.

Example 7 provides the method of any of the preceding examples, further including generating a bitmap for the weight tensor, the bitmap including a plurality of bits, each bit corresponding to a weight in the weight tensor and indicating whether the weight is quantized to an integer or a power of two value.

Example 8 provides the method of example 7, where a bit having a value of zero indicates that a corresponding weight is quantized to a power of two value, and a bit having a value of one indicates that a corresponding weight is quantized to an integer.

Example 9 provides the method of example 7 or 8, further including transmitting, based on the bitmap, the first group of one or more weights from a memory to one or more shifters; and transmitting, based on the bitmap, the second group of one or more weights from the memory to one or more multipliers.

Example 10 provides the method of any of the preceding examples, further including storing, in a memory, the exponent of the power of two value in lieu of the weight in the first group; and storing, in the memory, the integer in lieu of the weight in the second group.

Example 11 provides a compute block configured to execute a DNN, the compute block including a weight compressing module configured to select a first group of one or more weights from a weight tensor of a layer of the DNN, the weight tensor including the first group of one or more weights and a second group of one or more weights, quantize a weight in the first group to a power of two value, and quantize a weight in the second group to an integer; and a PE including a shifter configured to shift an activation of the layer by an exponent of the power of two value, and a multiplier configured to multiply the integer with another activation of the layer.

Example 12 provides the compute block of example 11, where the PE further includes one or more other shifters and one or more other multipliers.

Example 13 provides the compute block of example 12, where the PE further includes a first accumulator configured to accumulate outputs of the shifter and the includes one or more other shifters; and a second accumulator configured to accumulate outputs of the multiplier and the one or more other multipliers.

Example 14 provides the compute block of example 13, where the first accumulator is configured to accumulate the outputs of the shifter and the includes one or more other shifters at a first speed, the second accumulator configured to accumulate the outputs of the multiplier and the one or more other multipliers at a second speed, and the first speed is lower than the second speed.

Example 15 provides the compute block of example 14, where the first accumulator includes an adder compressor.

Example 16 provides the compute block of example 14 or 15, where the second accumulator includes a ripple-carry adder.

Example 17 provides the compute block of any one of examples 14-16, where the PE further includes a third accumulator configured to accumulate outputs of the first accumulator and the second accumulator.

Example 18 provides the compute block of any one of examples 11-17, where the compute block further includes a memory, the memory configured to store the exponent of the power of two value in lieu of the weight in the first group; and store the integer in lieu of the weight in the second group.

Example 19 provides the compute block of example 18, where the memory is further configured to store a bitmap for the weight tensor, the bitmap including a plurality of bits, each bit corresponding to a respective weight in the weight tensor and indicating whether the respective weight is quantized to an integer or a power of two value.

Example 20 provides the compute block of example 19, where the PE further includes an additional multiplier coupled to the shifter, and the PE is configured to determine to transmit the exponent of the power of two value to the shifter in lieu of the additional multiplier based on a bit in the bitmap that corresponds to the weight in the first group.

Example 21 provides one or more non-transitory computer-readable media storing instructions executable to perform operations for executing a layer of a DNN, the operations including selecting a first group of one or more weights from a weight tensor of a layer of the DNN, the weight tensor including the first group of one or more weights and a second group of one or more weights; quantizing a weight in the first group to a power of two value; quantizing a weight in the second group to an integer; shifting an activation of the layer by an exponent of the power of two value; and multiplying the integer with another activation of the layer.

Example 22 provides the one or more non-transitory computer-readable media of example 21, where the weight tensor includes a plurality of weights arranged in one or more rows and one or more columns, a number of weights in a row of the weight tensor is equal to a number of channels in an IFM of the layer, and a number of weights in a column of the weight tensor is equal to a number of channels in an output feature map of the layer.

Example 23 provides the one or more non-transitory computer-readable media of example 21 or 22, where selecting the first group of one or more weights from the weight tensor includes selecting the first group of one or more weights from the weight tensor based on a predetermined partition parameter, the partition parameter indicating a ratio of a number of weight or weights in the first group to a total number of weights in the weight tensor.

Example 24 provides the one or more non-transitory computer-readable media of any one of examples 21-23, where the operations further include generating a bitmap for the weight tensor, the bitmap including a plurality of bits, each bit corresponding to a weight in the weight tensor and indicating whether the weight is quantized to an integer or a power of two value.

Example 25 provides the one or more non-transitory computer-readable media of any one of examples 21-24, where the operations further include storing, in a memory, the exponent of the power of two value in lieu of the weight in the first group; and storing, in the memory, the integer in lieu of the weight in the second group.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method of executing a deep neural network (DNN), comprising:
selecting a first group of one or more weights from a weight tensor of a layer of the DNN, the weight tensor comprising the first group of one or more weights and a second group of one or more weights;
quantizing a weight in the first group to a power of two value;
quantizing a weight in the second group to an integer;
shifting an activation of the layer by an exponent of the power of two value; and
multiplying the integer with another activation of the layer.

2. The method of claim 1, wherein the weight tensor comprises a plurality of weights arranged in one or more rows and one or more columns, a number of weights in a row of the weight tensor is equal to a number of channels in an input feature map of the layer, and a number of weights in a column of the weight tensor is equal to a number of channels in an output feature map of the layer.

3. The method of claim 2, wherein selecting the first group of one or more weights from the weight tensor comprises:
selecting a same number of weight or weights from each respective row of the weight tensor.

4. The method of claim 1, wherein selecting the first group of one or more weights from the weight tensor comprises:
selecting the first group of one or more weights from the weight tensor based on a predetermined partition parameter, the partition parameter indicating a ratio of a number of weight or weights in the first group to a total number of weights in the weight tensor.

5. The method of claim 1, wherein selecting the first group of one or more weights from the weight tensor comprises:
selecting the first group of one or more weights from the weight tensor by minimizing a difference between the weight tensor and a tensor comprising one or more integers and one or more power or two values,
wherein the one or more integers are generated by quantizing the one or more weights in the first group, and the one or more power or two values are generated by quantizing the one or more weights in the second group.

6. The method of claim 1, further comprising:
dividing a whole weight tensor of the layer into the weight tensor and an additional weight tensor;
selecting a third group of one or more weights from the additional weight tensor; and
quantizing each respective weight in the third group to a power of two value,
wherein a ratio of a number of weight or weights in the first group to a number of weights in the weight tensor is different from a ratio of a number of weight or weights in the third group to a number of weights in the additional weight tensor.

7. The method of claim 1, further comprising:
generating a bitmap for the weight tensor, the bitmap comprising a plurality of bits, each bit corresponding to a weight in the weight tensor and indicating whether the weight is quantized to an integer or a power of two value.

8. The method of claim 7, wherein a bit having a value of zero indicates that a corresponding weight is quantized to a power of two value, and a bit having a value of one indicates that a corresponding weight is quantized to an integer.

9. The method of claim 7, further comprising:
transmitting, based on the bitmap, the first group of one or more weights from a memory to one or more shifters; and
transmitting, based on the bitmap, the second group of one or more weights from the memory to one or more multipliers.

10. The method of claim 1, further comprising:
storing, in a memory, the exponent of the power of two value in lieu of the weight in the first group; and
storing, in the memory, the integer in lieu of the weight in the second group.

11. An apparatus, comprising:
a computer processor for executing computer program instructions; and
a non-transitory computer-readable memory storing computer program instructions executable by the computer processor to perform operations comprising:
selecting a first group of one or more weights from a weight tensor of a layer of the DNN, the weight tensor comprising the first group of one or more weights and a second group of one or more weights,
quantizing a weight in the first group to a power of two value,
quantizing a weight in the second group to an integer,
shifting an activation of the layer by an exponent of the power of two value, and
multiplying the integer with another activation of the layer.

12. The apparatus of claim 11, wherein the weight tensor comprises a plurality of weights arranged in one or more rows and one or more columns, a number of weights in a row of the weight tensor is equal to a number of channels in an input feature map of the layer, and a number of weights in a column of the weight tensor is equal to a number of channels in an output feature map of the layer.

13. The apparatus of claim 11, wherein selecting the first group of one or more weights from the weight tensor comprises:
selecting the first group of one or more weights from the weight tensor based on a predetermined partition parameter, the partition parameter indicating a ratio of a number of weight or weights in the first group to a total number of weights in the weight tensor.

14. The apparatus of claim 11, wherein the operations further comprise:
generating a bitmap for the weight tensor, the bitmap comprising a plurality of bits, each bit corresponding to a weight in the weight tensor and indicating whether the weight is quantized to an integer or a power of two value.

15. The apparatus of claim 11, wherein the operations further comprise:
storing, in a memory, the exponent of the power of two value in lieu of the weight in the first group; and
storing, in the memory, the integer in lieu of the weight in the second group.

16. One or more non-transitory computer-readable media storing instructions executable to perform operations for executing a layer of a deep neural network (DNN), the operations comprising:
selecting a first group of one or more weights from a weight tensor of a layer of the DNN, the weight tensor comprising the first group of one or more weights and a second group of one or more weights;
quantizing a weight in the first group to a power of two value;
quantizing a weight in the second group to an integer;
shifting an activation of the layer by an exponent of the power of two value; and
multiplying the integer with another activation of the layer.

17. The one or more non-transitory computer-readable media of claim 16, wherein the weight tensor comprises a plurality of weights arranged in one or more rows and one or more columns, a number of weights in a row of the weight tensor is equal to a number of channels in an input feature map of the layer, and a number of weights in a column of the weight tensor is equal to a number of channels in an output feature map of the layer.

18. The one or more non-transitory computer-readable media of claim 16, wherein selecting the first group of one or more weights from the weight tensor comprises:
selecting the first group of one or more weights from the weight tensor based on a predetermined partition parameter, the partition parameter indicating a ratio of a number of weight or weights in the first group to a total number of weights in the weight tensor.

19. The one or more non-transitory computer-readable media of claim 16, wherein the operations further comprise:
generating a bitmap for the weight tensor, the bitmap comprising a plurality of bits, each bit corresponding to a weight in the weight tensor and indicating whether the weight is quantized to an integer or a power of two value.

20. The one or more non-transitory computer-readable media of claim 16, wherein the operations further comprise:
storing, in a memory, the exponent of the power of two value in lieu of the weight in the first group; and
storing, in the memory, the integer in lieu of the weight in the second group.
